(19) United States
(12) Patent Application Publication
(10) Pub. No.: US 2014/0032258 A1
(43) Pub. Date: Jan. 30, 2014

(54) EXTRACTING APPARATUS AND EXTRACTING METHOD

(71) Applicant: FUJITSU LIMITED, Kawasaki-shi (JP)

(72) Inventor: Shingo KATO, Yokohama (JP)

(73) Assignee: FUJITSU LIMITED, Kawasaki-shi (JP)

(21) Appl. No.: 13/896,773

(22) Filed: May 17, 2013

(30) Foreign Application Priority Data
Jul. 30, 2012 (JP) 2012-168813

(51) Int. Cl. G06Q 10/06

(52) U.S. Cl. CPC G06Q 10/0633
USPC 705/7.27

(57) ABSTRACT

An extracting apparatus includes a processor configured to calculate a first frequency of updates in a first workflow and second frequencies of updates in each of a plurality of second workflows, each of which includes activities of the first workflow and one or more activities, with regard to each of a plurality of parameters used in the first workflow and the plurality of second workflows, select a first parameter from the plurality of parameters, based on differences, relating to each of the plurality of parameters, from the first frequency to each of the second frequencies, and extract a second workflow from the plurality of second workflows, based on differences from a value of the first parameter after termination of the first workflow to each of values of the first parameter after termination of the plurality of second workflows.

### CROSS-REFERENCE TO RELATED APPLICATION

This application is based upon and claims the benefit of priority from the prior Japanese Patent Application No. 2012-168813 filed on Jul. 30, 2012, the entire contents of which are incorporated herein by reference.

### FIELD

The embodiments discussed herein are related to processing for data indicating workflows.

### BACKGROUND

With organizations using business process management (BPM) systems, business operations are carried out using workflows defined beforehand for each business operation. The term “workflow” refers to a series of business operation processing executed on a computer system such as a BMP system, with regard to some business operation process.

A workflow defined beforehand (hereinafter referred to as “standard flow”) may be customized in some cases, to improve a business operation process or the like. There are some workplaces where individuals are permitted to customize standard flows. In a case where individuals customize a standard flow, there is a situation in which a standard flow and multiple workflows obtained by the standard flow having been customized (hereinafter referred to as “custom flow”) coexist with regard to the same business operation.

In the event that multiple custom flows exist with regard to a single business operation, being able to extract custom flows with relatively high usage values could be expected to improve operation efficiency of the overall organization, increase sales, and so forth.

Heretofore, extraction of workflows has been performed based on usage frequency or lead time. That is to say, workflows with high usage frequency or workflows with short lead times have been extracted as workflows with high usage value. Examples include Japanese Laid-open Patent Publication Nos. 2010-102615 and 2009-251899.

Nonetheless, the recognition of custom workflows is generally lower than the standard flow, when it comes to individuals creating custom flows. Accordingly, the probability that the standard flow will be extracted is high with the method where workflows are extracted based on usage frequency. Thus, this method is far from effective regarding extracting custom flows with high usage value.

Also, in the event of extracting work flows based on lead time, there are cases where a custom flow with a relatively short lead time is actually less likely to achieve business operation objects than a custom flow with a relatively long lead time.

For example, let us say that there is a standard flow and multiple custom flows regarding personal computer (PC) lending business operations. In this case, if the lead time of a custom flow A is longer than that of a custom flow B, but custom flow A is more likely to achieve lending of the number of PCs applied for, we may say that the usage value of the custom flow A is higher. Thus, extracting workflows based on lead time is far from effective regarding extracting custom flows with high usage value in a stable manner.

### SUMMARY

According to an aspect of the invention, an apparatus includes an extracting apparatus includes a processor configured to calculate a first frequency of updates in a first workflow and second frequencies of updates in each of a plurality of second workflows, each of which includes activities of the first workflow and one or more activities, with regard to each of a plurality of parameters used in the first workflow and the plurality of second workflows, select a first parameter from the plurality of parameters, based on differences, relating to each of the plurality of parameters, from the first frequency to each of the second frequencies, and extract a second workflow from the plurality of second workflows, based on differences from a value of the first parameter after termination of the first workflow to each of values of the first parameter after termination of the plurality of second workflows.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the configuration of a workflow system according to an embodiment;

FIG. 2A illustrates an example of customizing a workflow;

FIG. 2B illustrates an example of customizing a workflow;

FIG. 3 illustrates an example of a lending flow;

FIG. 4 illustrates an example of parameters of a lending flow;

FIG. 5 illustrates a hardware configuration example of a workflow extracting device according to an embodiment;

FIG. 6 illustrates a functional configuration example of a workflow managing device and workflow extracting device according to an embodiment;

FIG. 7 illustrates a relation between workflow definitions and execution results;

FIG. 8 illustrates an example of the contents of results of having executed a certain workflow once, and information recorded;

FIG. 9A illustrates a calculation example of updating frequency relating to one workflow;

FIG. 9B illustrates a calculation example of updating frequency relating to one workflow;

FIG. 10A illustrates an example of calculation of difference in updating frequency;

FIG. 10B illustrates an example of calculation of difference in updating frequency;

FIG. 11A illustrates an example of calculating average values of parameters when a workflow ends;

FIG. 11B illustrates an example of calculating average values of parameters when a workflow ends;

FIG. 12 illustrates an example of calculating difference of parameter values of custom flows and the standard flow when the workflow ends;

FIG. 13 illustrates a specific example of a standard flow used for describing processing procedures;

FIG. 14 illustrates an example of processing procedures which the workflow extracting device executes;

FIG. 15 illustrates a specific example of custom flows used for describing processing procedures;

FIG. 16 illustrates an example of parameter information specified in a recording request of execution results of a standard activity;

FIG. 17 illustrates an example of storing parameter values in a parameter value storage unit;

FIG. 18 illustrates an example of recording update information at an update information storage unit;

FIG. 19 illustrates an example of parameter information specified in a recording request of execution results of a custom activity;

FIG. 20 illustrates an example of updating of the parameter value storage unit;

FIG. 21 illustrates an example of updating of the update information storage unit;

FIG. 22 illustrates an example of processing procedures for extracting processing of a recommended flow;

FIG. 23 illustrates an example of a state of the parameter value storage unit when extracting a recommended flow;

FIG. 24 illustrates an example of processing procedures for related parameter identifying processing;

FIG. 25 illustrates a configuration example of a parameter attribute table;

FIG. 26 illustrates an example of processing procedures for suitability determination processing of related parameters;

FIG. 27 illustrates an example of updating the parameter attribute table;

FIG. 28 illustrates an example of processing procedures for related parameter identifying processing based on update information;

FIG. 29 illustrates an example of the state of the update information storage unit when extracting a recommended flow;

FIG. 30 illustrates a specific example of an updating frequency table;

FIG. 31 illustrates a configuration example of an updating frequency difference table;

FIG. 32A illustrates an example of deleting difference of updating frequency relating to activity earlier than custom activity;

FIG. 32B illustrates an example of deleting difference of updating frequency relating to activity earlier than custom activity;

FIG. 33 illustrates an example of processing procedures for updating frequency calculating processing for each candidate parameter relating to each activity of each workflow;

FIG. 34 illustrates an example of calculation processing of the difference between updating frequency of each candidate parameter for each custom flow and updating frequency of each candidate parameter for the standard flow;

FIG. 35 illustrates an example of deleting processing of difference in updating frequency relating to activity earlier than custom activity;

FIG. 36 illustrates an example of processing procedures for related parameter identifying processing based on the difference in updating frequency;

FIG. 37A illustrates a calculation example of the average in absolute values in difference of updating frequency in increments of activities;

FIG. 37B illustrates a calculation example of the average in absolute values in difference of updating frequency in increments of activities;

FIG. 38 illustrates a calculation example of summation of average updating frequency difference for each candidate parameter;

FIG. 39 illustrates a second updating example of the parameter attribute table;

FIG. 40 illustrates an example of processing procedures for calculation processing of average updating frequency difference in increments of activities;

FIG. 41 illustrates an example of processing procedures for calculation processing of summation of average updating frequency difference for each candidate parameter;

FIG. 42 illustrates an example of processing procedures for recommended flow extracting processing based on related parameters;

FIG. 43 illustrates a configuration example of a related parameter average value table;

FIG. 44 illustrates an example of calculation of difference between the average value of a related parameter of each custom flow and the average value of a related parameter of the standard flow;

FIG. 45 illustrates an example of processing procedures for average value calculating processing of related parameters for each workflow;

FIG. 46 illustrates an example of processing procedures for calculation processing of the difference between the average values of related parameters of each custom flow and the average values of related parameters of the standard flow;

FIG. 47 illustrates a first example of processing procedures for recommended flow selection processing based on the difference of related parameters;

FIG. 48 illustrates a second example of processing procedures for recommended flow selection processing based on the difference of related parameters;

FIG. 49 illustrates an example of parameter attribute information specified in a workflow extracting request;

FIG. 50 illustrates an example of updating a parameter attribute table based on parameter attribute information;

FIG. 51 illustrates a second specific example of an updating frequency table;

FIG. 52 illustrates a second specific example of an updating frequency difference table;

FIG. 53 illustrates a second example of deleting difference of updating frequency relating to activity earlier than custom activity;

FIG. 54 illustrates a second specific example of an average updating frequency difference table;

FIG. 55 illustrates a second specific example of an average updating frequency difference summation table; and

FIG. 56 illustrates an example of updating the parameter attribute table based on the second specific example of an average updating frequency difference summation table.

### DESCRIPTION OF EMBODIMENT

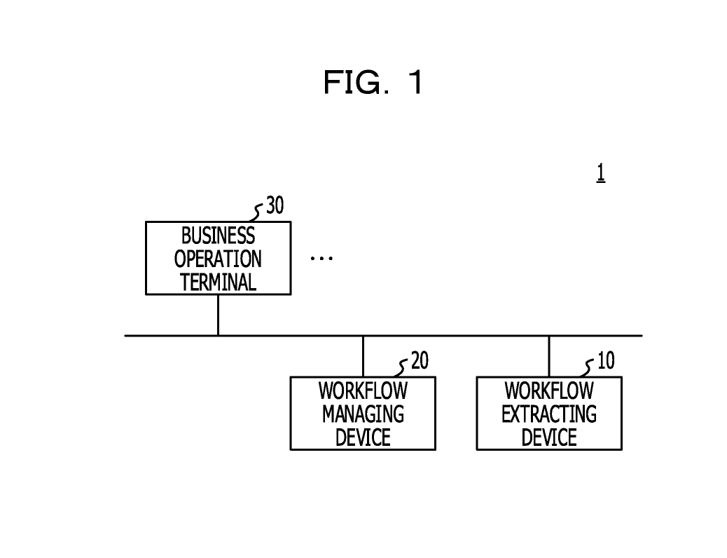

An embodiment will be described with reference to the drawings. FIG. 1 illustrates an example of the configuration of a workflow system according to the embodiment. In a workflow system 1 illustrated in FIG. 1, one or more business operation terminals 30, a workflow managing device 20, and a workflow extracting device 10 are communicably connected via a network such as a local area network (LAN), the Internet, or the like.

The business operation terminal 30 is an information processing terminal which a user of the workflow system 1 operates. Examples of a business operation terminal 30 include a PC, tablet terminal, smartphone, cellular phone, and personal digital assistant (PDA).

The workflow managing device 20 is a computer which stores definition information of various types of workflows, and executes processing procedures to realize these workflows based on definition information of workflows requested by a business operation terminal 30. With the present embodiment, the term “workflow” means a series of business operation processing executed on an information processing system with regard to some business operation process. Each workflow includes one or more activities as component elements. An activity is a task increment within a workflow. Note however, that in practice, multiple business operation tasks may be defined as a single activity. That is to say, the increments of tasks defined as activities is optionally decided by the workflow designer or the like. For example, an activity often corresponds to an operating screen, i.e., human operation. However, with a money transfer workflow for example, an activity may be processing to which human operation does not contribute, such as “balance confirmation” where a payers bank account is checked regarding whether there is a balance equal to or exceeding the amount of transfer, “account referral” where the existence of a payee account is confirmed, and so forth.

In response to a request from the workflow managing device 20, the workflow extracting device 10 extracts, from multiples, a workflow having a relatively high usage value (hereinafter referred to as “recommended flow”). A workflow population serving as a source from which to extract a recommended flow is multiple workflows created by customizing a certain standard flow. A standard flow is an already-existing workflow originally defined regarding a certain business operation. A workflow of which the standard flow has been customized is created by, for example, a certain user individually customizing a part of the standard flow.

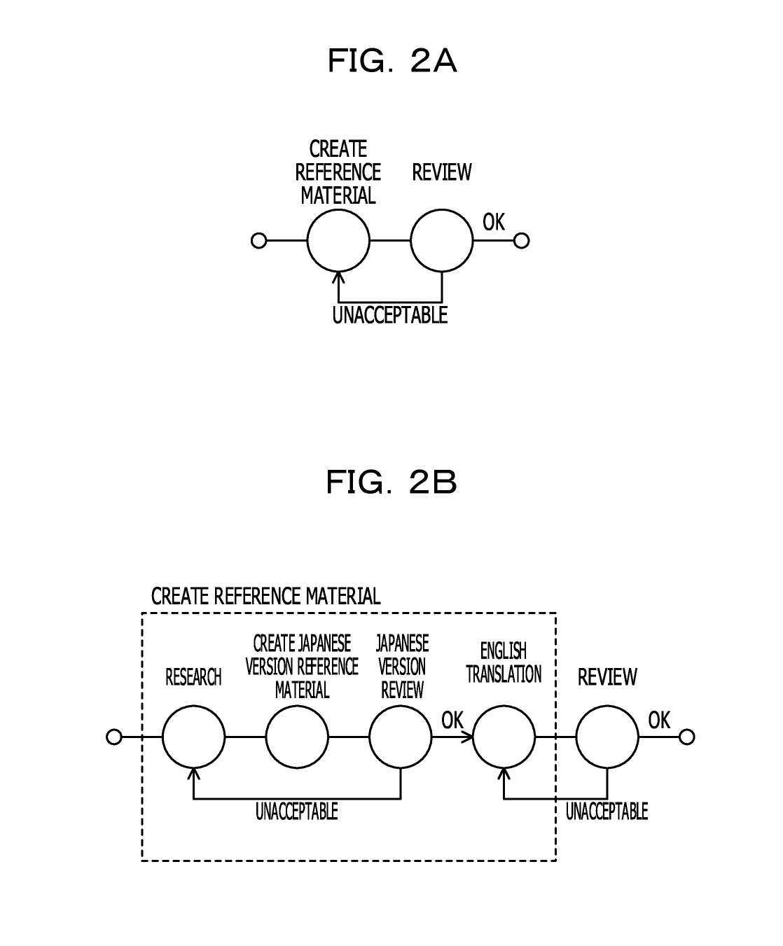

FIGS. 2A and 2B illustrate an example of customizing a workflow. FIG. 2A is a diagram illustrating a definition of a standard flow relating to a reference material creating business operation. This standard flow includes two activities, which is a reference material creating activity, and a review activity. In FIGS. 2A and 2B, activities making up a workflow are represented by circles, with the activities being connected by line segments or the like following the order in which the activities are to be executed. Hereinafter a diagram which defines a workflow with the format illustrated in FIGS. 2A and 2B will be referred to as a “flow diagram”.

On the other hand, FIG. 2B is a custom flow diagram created by customizing the standard flow illustrated in FIG. 2A. The reference material creating activity in the standard flow has been broken down into a research activity, Japanese version reference material creating activity, Japanese version review activity, and English translation activity. In other words, with this custom flow, the reference material creating activity has been replaced by the research activity, Japanese version reference material creating activity, Japanese version review activity, and English translation activity.

Thus, customizing of a standard flow is performed in increments of activities. Examples of customization include partial deletion activities from the standard flow, partial replacement of activities, addition of activities of the standard flow, and so forth.

Hereinafter, for sake of convenience, we will refer to the relationship between a standard flow and a custom flow as a parent-child relationship. The standard flow is the parent flow, and the custom flow is the child flow. Multiple child flows may be defined for a single parent flow. With regard to workflows having parent-child relationships, all or part of custom flows as to the standard flow is called a set of custom flows. Also, a group of child flows having the same parent flow will be referred to as “sibling flows”.

Note that while the standard flow and custom flows have the same business operation to be handled and the same objectives, the likelihood that the degree of achievement of the objectives will differ when executed is high. The reason is that a custom flow has likely been created to raise the degree of achievement of the objectives. Here, the term “objectives” refers to objectives of the business operation to which the workflow has been applied. The term “degree of achievement of objectives” is the degree to which the objects of the business operation have been achieved. Hereinafter, an index indicating the degree of achievement of the objectives will be referred to as “objectives achievement degree”.

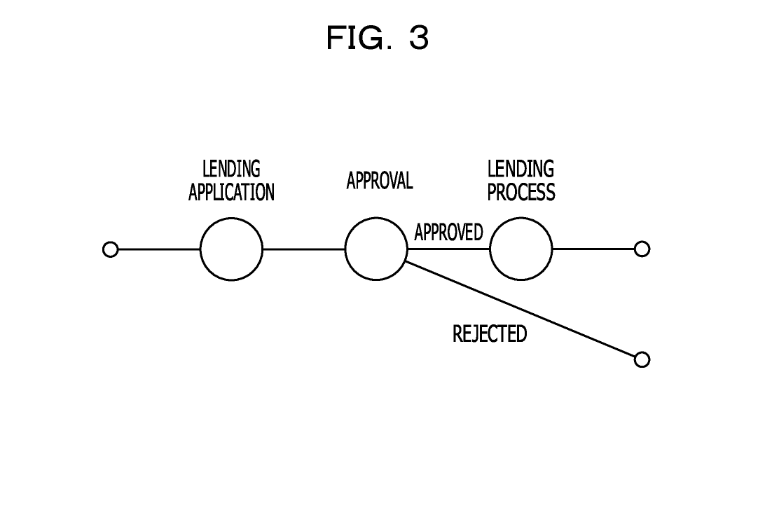

The objectives achievement degree will be described based on a specific example. Let us say that a workflow which receives lending of PCs, wherein PCs are temporarily lent to employees of a corporation, has been defined as illustrated in FIG. 3.

FIG. 3 is a diagram illustrating an example of a lending flow. The lending flow illustrated in FIG. 3 is a workflow where tasks are performed in the order of lending application activity, approval activity, and lending processing activity. With the lending application activity, an employee who desires to borrow a PC performs a lending application. With the approval activity, the application to lend is approved or rejected by an approver. In the event that the application has been approved, the lending processing activity is executed. With the lending processing activity, lending processing corresponding to the contents of the approval is performed.

The objectives achievement degree relating to such a rental flow may be expressed by the number of units lent, for example. For example, if the number of units lent is 50, the objectives achievement degree may be expressed as 50. Also, if the number of units lent is 100, the objectives achievement degree may be expressed as 100. Alternatively, the objectives achievement degree may be expressed by the percentage of units lent as to the number of units regarding which lending is desired.

Now, if we say that there is a custom flow as to the lending flow, and the objectives achievement degree tends to be higher when this custom flow is executed, we may say that the custom flow has a higher usage value. Accordingly, with the present embodiment, we will use the objectives achievement degree as an index to measure how high the usage value of a workflow is.

Now, “units desired” and “units lent” above are parameters used in the lending flow. We may also say that parameters are attribute items of the workflow.

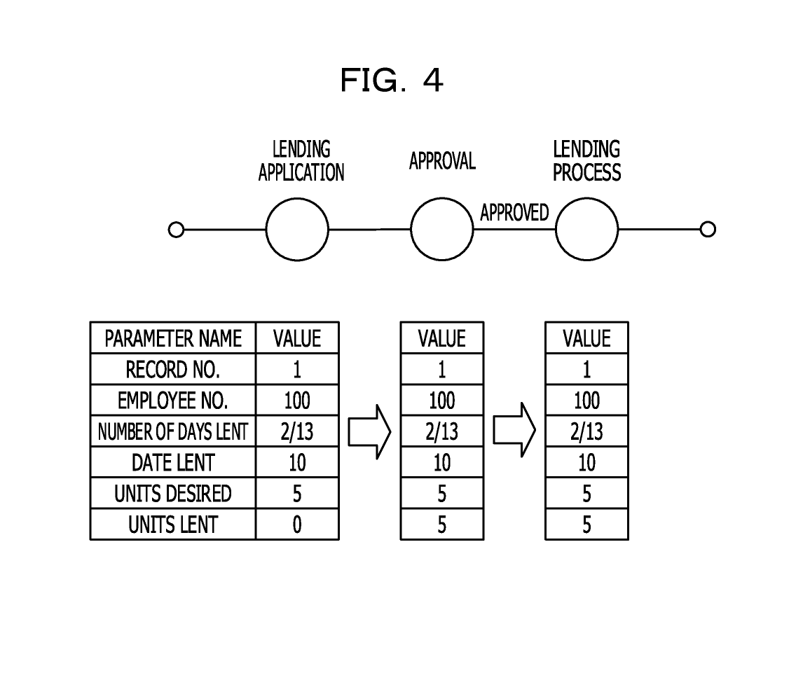

For example, parameters used in the lending flow may include those such as illustrated in FIG. 4, besides “units desired” and “units lent”.

FIG. 4 is a diagram illustrating an example of parameters of the lending flow. In FIG. 4, the parameter name, and updating examples of values of the parameter at each activity, are illustrated for each parameter used in the lending flow.

With the lending flow illustrated in FIG. 4, parameters such as “record No.”, “employee No.”, “date lent”, “number of days lent”, “units desired”, and “units lent” are used. Of these, the objectives achievement degree may be determined by referencing “units lent”. That is to say, the parameters used within the workflow may be referenced to determine the objectives achievement degree of the workflow. Note however, that the computer does unit know the meaning of the parameters from the parameter names alone. For example, the computer does not know which of the parameters is deeply correlated with the objectives achievement degree, simply based on the parameter names. With the example in FIG. 4, the parameter related to the objectives achievement degree is “units lent”, but as far as the computer is able to tell, this is but one of multiple parameters used within the workflow. As described later, the workflow extracting device 10 estimates a parameter deeply related to the objectives achievement degree (hereinafter referred to as “related parameter”), and extracts a recommended flow based on the value of the related parameter when the custom flow ends, and so forth.

Note that the functions of the workflow managing device 20 and workflow extracting device 10 may each be implemented in a single computer. For example, at least one of the functions of the workflow managing device 20 and workflow extracting device 10 may be implemented in the business operation terminal 30.

Also, the workflow system 1 make up all or part of a BPM system.

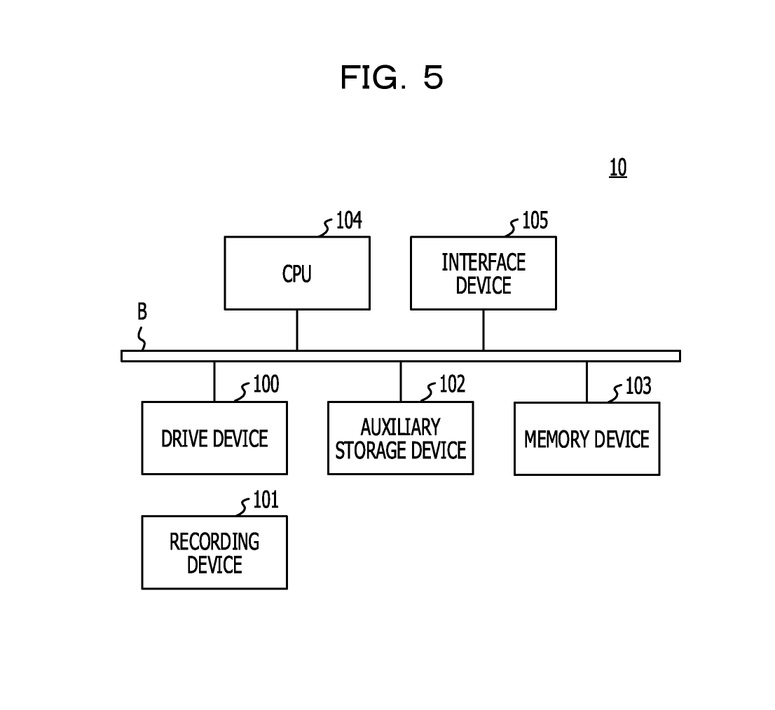

FIG. 5 is a diagram illustrating a hardware configuration example of a workflow extracting device according to the present embodiment. The workflow extracting device 10 in FIG. 5 includes a drive device 100, an auxiliary storage device 102, a memory device 103, a CPU 104, an interface device 105, and so forth, mutually connected by a bus B. The CPU 104 is an example of a processor. The processor is a hardware to carry out operations based on at least one program and control other hardware, such as the CPU 104, a GPU (Graphics Processing Unit), FPU (Floating point number Processing Unit) and DSP (Digital signal Processor).

A program realizing processing at the workflow extracting device 10 is provided by a recording medium 101. Upon the recording medium 101 in which the program has been recorded being set to the drive device 100, the program is installed from the recording medium 101 to the auxiliary storage device 102 via the drive device 100. Note however, installation of the program is not restricted to being performed from the recording medium 101, and may be downloaded from another computer via network. The auxiliary storage device 102 stores installed programs, and also stores files and data and the like to be used.

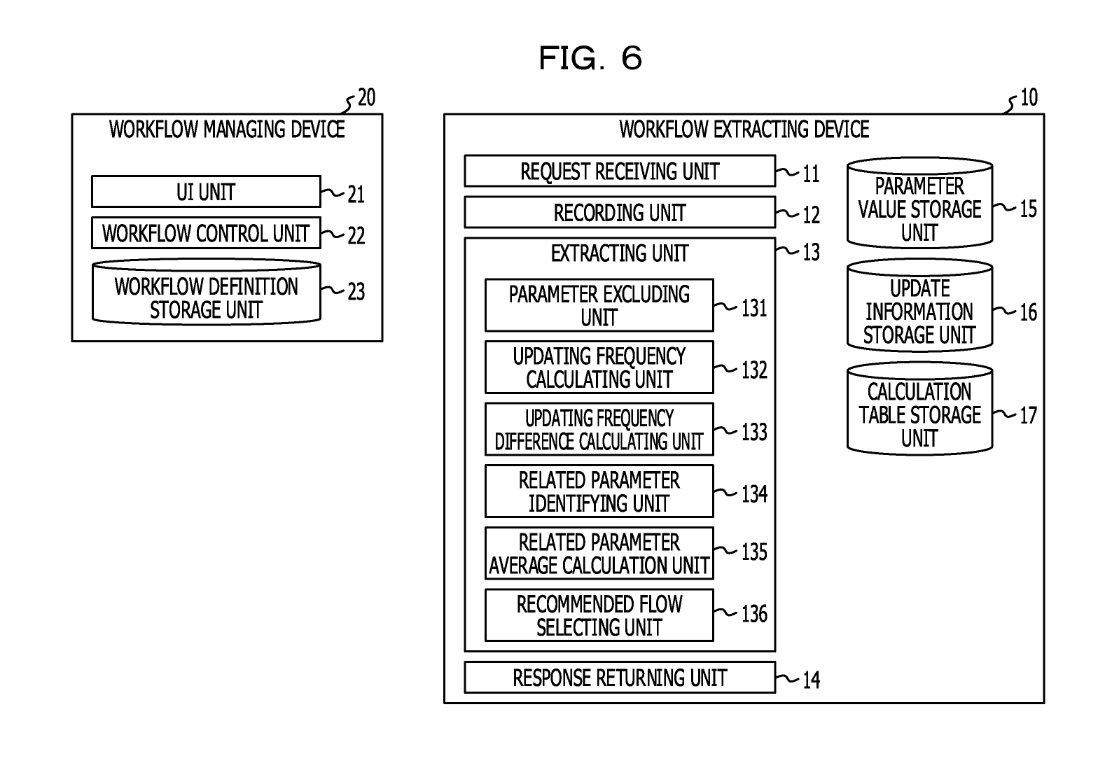

In the event of a program activation instruction, the memory device 103 reads out the program from the auxiliary storage device 102 and stores this. The CPU 104 executes functions relating to the workflow extracting device 10 (such as a request receiving unit 11, a recording unit 12, an extracting unit 13 and a response returning unit 14 in FIG. 6 described below) in accordance with the program stored in the memory device 103. The interface device 105 is used to connected to a network.

Examples of the recording medium 101 include CD-ROM or DVD disks, USB memory, and other like portable recording media. Also, examples of the auxiliary storage device 102 include a hard disk drive (HDD) and flash memory and so forth. Both the recording medium 101 and the auxiliary storage device 102 are computer-readable recording media.

FIG. 6 is a diagram illustrating a functional configuration example of a workflow managing device and workflow extracting device according to the embodiment.

In FIG. 6, the workflow managing device 20 has a user interface (hereinafter “UI”) unit 21 and a workflow control unit 22 and so forth. These components are realized by processing in which one or more programs installed to the workflow managing device 20 are executed by a CPU of the workflow managing device 20. The workflow managing device 20 also uses a workflow definition storage unit 23. The workflow definition storage unit 23 may be realized using an auxiliary storage device which the workflow managing device 20 has, a storage device connected to the workflow managing device 20 via network, or the like.

The UI unit 21 executes transmission of information to receive instruction input from the user, information requested in the instruction input, and so forth, to the business operation terminal 30. Based on definition information of the workflow which is to be executed, the workflow control unit 22 executes processing to realize this workflow. Hereinafter, definition information of the workflow will be referred to as “workflow definition”. The workflow definition storage unit 23 stores workflow definitions in correlation with identifiers of the workflows. The workflow definition storage unit 23 also stores information indicating a parent-child relationship between workflows. For example, in correlation with a parent flow, the identifier of each child flow as to this parent flow is stored as information indicating the parent-child relationship. Alternatively, in correlation with each child flow, the identifier of the parent flow as to this child flow may be stored as information indicating the parent-child relationship. Hereinafter, identifiers of the workflows will be referred to as “flow IDs”.

The workflow extracting device 10 includes a request receiving unit 11, a recording unit 12, an extracting unit 13, and a response returning unit 14 and so forth. Each of these components are realized by processing in which one or more programs installed to the workflow extracting device 10 are executed by the CPU 104 of the workflow extracting device 10. The workflow extracting device 10 also uses a parameter value storage unit 15, an update information storage unit 16, a calculation table storage unit 17, and so forth. These storage units may be realized using the auxiliary storage device 102, a storage device connected to the workflow extracting unit 10 via network, or the like.

The request reception unit 11 receives requests from the workflow managing device 20. For example, a recording request for execution results of a workflow, an extraction request for a workflow, and so forth, are examples of requests from the workflow managing device 20. A recording request for execution results of a workflow is transmitted from the workflow managing device 20 when execution of a certain workflow has ended. An extraction request for a workflow is transmitted from the workflow managing device 20 to recommend or present the user with the workflow to be executed, when executing these workflows.

Note that execution results of a workflow are a set of a series of activities executed by the workflow managing device 20 relating to that workflow, and may be generated multiple times for one workflow definition. Specifically, the number of execution results of a workflow are generated is equal to the number of times that the workflow definition has been executed.

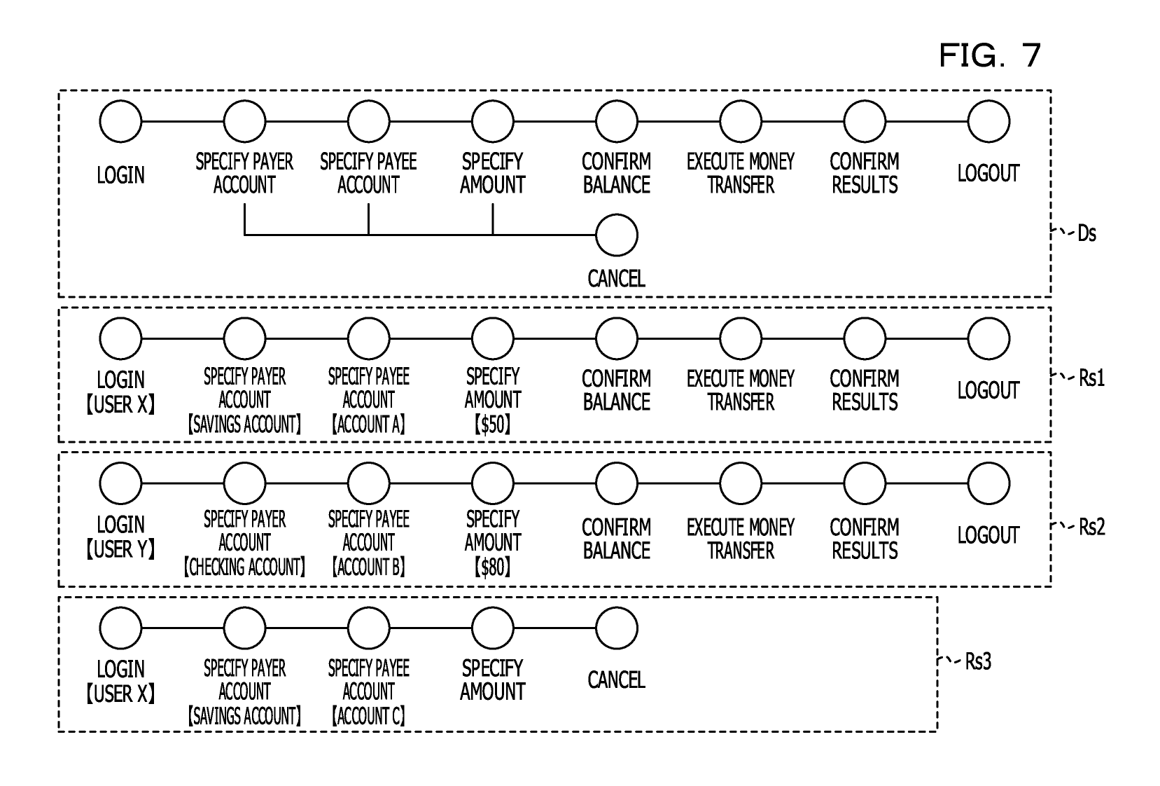

FIG. 7 is a diagram illustrating the relationship between workflow definition and execution results. In FIG. 7, definition Ds is a definition of a workflow of a money transfer business operation (hereinafter referred to as “money transfer flow”). With the definition Ds, the money transfer flow includes activities such as “login”, “specify payer account”, “specify payee account”, “specify amount”, “confirm balance”, “execute money transfer”, “confirm execution results”, “cancel”, and “logout” and so forth.

On the other hand, execution results Rs1 and Rs2 are the results of having executed activities such as “login”, “specify payer account”, “specify payee account”, “specify amount”, “confirm balance”, “execute money transfer”, “confirm execution results”, and “logout” and so forth, with regard to the money transfer flow. Note however, the parameters values of the login user name, payer account, payee account, amount, and so forth, differ between the execution results Rs1 and Rs2.

Also, execution results Rs3 are the results of having executed activities such as “login”, “specify payer account”, “specify payee account”, “specify amount”, and “cancel” and so forth, with regard to the money transfer flow. That is to say, the execution results Rs3 are an example of a money transfer having been cancelled partway through.

Thus, multiple execution results occur based on the same definition Ds. Also, values to the same parameter may differ among the execution results. Note that in the present embodiment, the term “workflow” as such means workflow definition.

Upon receiving a recording request for execution results of a workflow, the recording unit 12 records the contents of the execution results, and information based on the contents of the execution results, and so forth, in the parameter value storage unit 15 or update information storage unit 16.

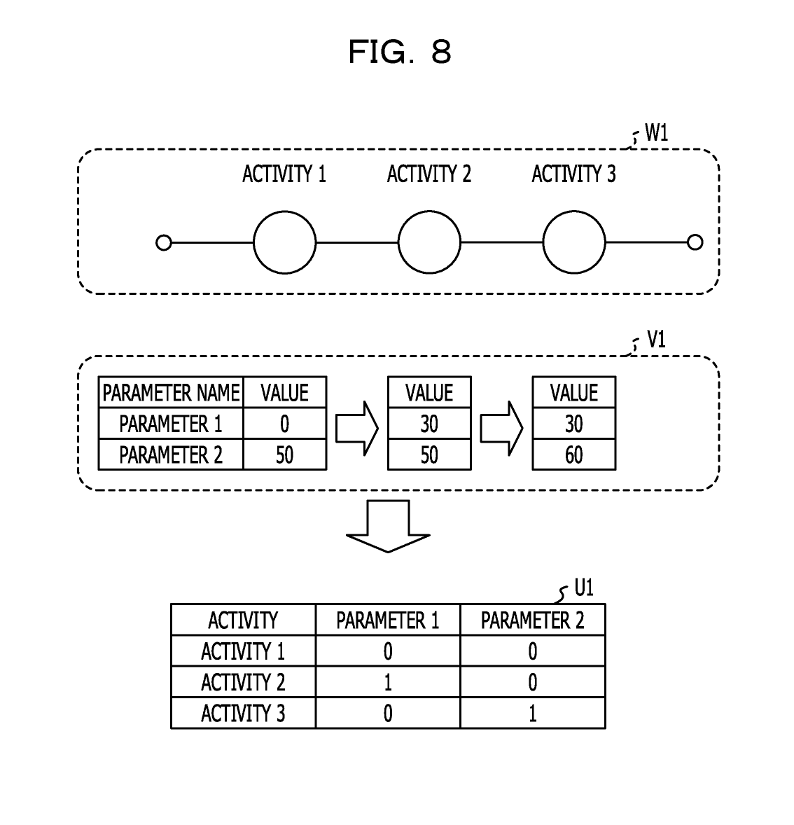

FIG. 8 is a diagram illustrating an example of contents of one time of execution results of a certain workflow, and information recorded. In FIG. 8, an example where a workflow W1 has ben executed is illustrated. The workflow W1 includes three activities of activity 1 through 3, and is a workflow in which activity 1 through 3 are executed in that order.

In FIG. 8, parameter value information V1 is illustrated as information indicating the contents of execution results of the workflow W1. For each activity, the parameter value information V1 includes a value after having executed that activity, relating to each parameter which the workflow W1 uses. An example where the workflow W1 uses parameters 1 and 2 is illustrated in the example in FIG. 8. We will say that the initial value of parameter 1 is 0, and the initial value of parameter 2 is 50. In activity 1, none of the parameters are updated. In activity 2, the value of parameter 1 has been updated to 30. In activity 3, the value of parameter 2 has been updated to 60. In this way, the execution results of a workflow included in an execution result recording request include the values of the parameters after having executed each activity making up the workflow. Of the parameter value information V1, the parameter values at the time of ending the workflow are stored in the parameter value storage unit 15 in a manner correlated with the flow ID of the workflow W1. That is to say, the parameter value storage unit 15 stores the parameter values at the time of ending the workflow, for the execution results of each workflow. The term “parameter values at the time of ending the workflow” means the values of the parameters after having executed the last activity in the workflow.

In FIG. 8, update information U1 is information indicating regarding the parameter value information V1 whether or not there has been updating of the parameters, for each activity. “0” indicates that there has been no update, and “1” indicates that there has been an update. For activity 1, there is no update of either parameters so 0 is provided to both parameter 1 and parameter 2. In activity 2, parameter 1 has been updated, is 1 is provided to parameter 1. In activity 3, parameter 2 has been updated, is 1 is provided to parameter 2.

The update information U1 is generated by the recording unit 12 based on the parameter value information V1, and is recorded in the update information storage unit 16 in a manner correlated with the flow ID of the workflow W1. That is to say, the update information storage unit 16 records whether or not there has been updating of each parameter by each activity making up this workflow, for each of the execution results of each workflow.

In the event of having received a workflow extracting request, the extracting unit 13 extracts a recommended flow from the sibling flows having the standard flow specified in this extracting request as a parent. The extracting processing by the extracting unit 13 is generally divided into two processes, of related parameter identifying processing, and extracting processing of a recommended flow based on a related parameter.

In the related parameter identifying processing, a parameter is extracted as a related parameter from parameters included in the parent flow or child flow group, which is estimated to have a relatively strong correlation as to objectives achievement degree, or to have relatively great influence on the objectives achievement degree.

In the recommended flow extracting processing, a recommended flow is extracted from the child flow group based on the related parameter values in the past execution results of each child flow.

In order to execute the above processing, the extracting unit 13 has a parameter excluding unit 131, an update frequency calculating unit 132, an update frequency difference calculating unit 133, a related parameter identifying unit 134, a related parameter average calculating unit 135, and a recommended flow selecting unit 136 and so forth. Of these, the parameter excluding unit 131, update frequency calculating unit 132, update frequency difference calculating unit 133, and related parameter identifying unit 134 execute the related parameter identifying procedures. The related parameter average calculating unit 135 and recommended flow selecting unit 136 execute the recommended flow extracting procedures.

The parameter excluding unit 131 excludes, from the parameters which the standard flow and each of the custom flows use, parameters having a high likelihood of not being a related parameter. Accordingly, parameters processed by the update frequency calculating unit 132 and thereafter are parameters which were not excluded by the parameter excluding unit 131.

The update frequency calculating unit 132 calculates the updating frequency of each of the parameters, relating to each activity of the standard flow and each custom flow. The term “updating frequency” means the frequency or rate at which parameters are updated in each activity, as to the number of times the workflow is executed.

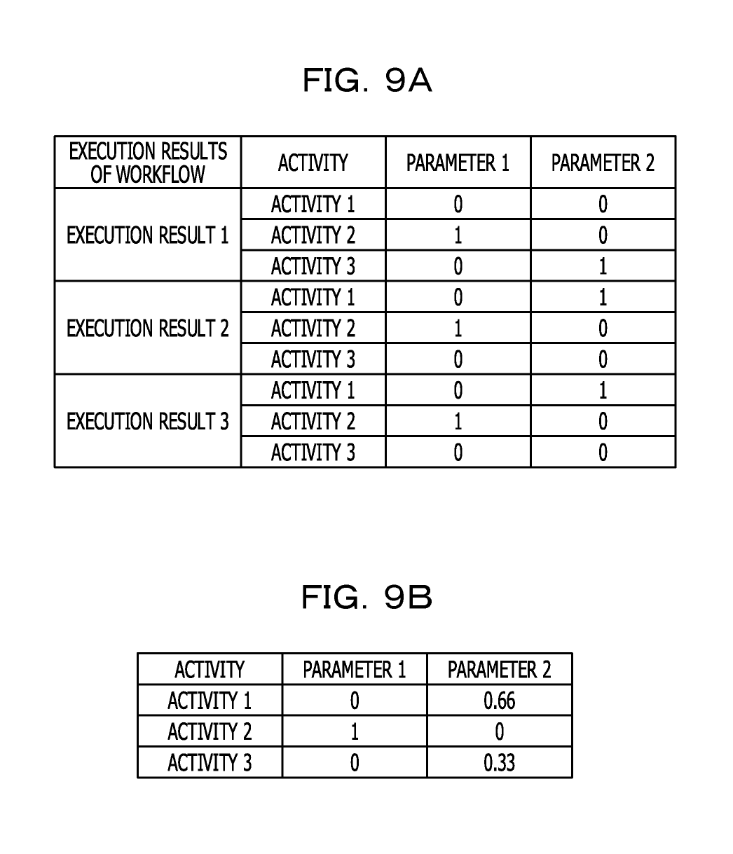

FIGS. 9A and 9B illustrate a calculation example of updating frequency relating to one workflow. FIG. 9A illustrates an example of information stored in the update information storage unit 16, relating to three times worth of experiment results of one certain workflow. From this information, we see that this workflow includes three activities of activities 1 through 3, and uses two parameters of parameters 1 and 2.

FIG. 9B illustrates calculation results of updating frequency based on the information in FIG. 9A. For example, the updating information of parameter 1 with regard to activity 1 is 0, 0, and 0, in the order of experiment results 1 through 3. In this case, the parameter 1 updating frequency relating to activity 1 is calculated as (0+0+0)/3=0. Also, the updating information of parameter 2 with regard to activity 1 is 0, 1, and 1, in the order of experiment results 1 through 3. In this case, the parameter 2 updating frequency relating to activity 1 is calculated as (0+1+1)/3=0.66. The parameters for the other activities also have the updating frequency calculated by the same computation processing.

While FIGS. 9A and 9B illustrate a calculation example of updating frequency relating to one workflow, the update frequency calculating unit 132 calculate the updating frequency relating to each activity of the standard flow and each custom flow. By calculating the updating frequency relating to each activity of the standard flow and each custom flow, the updating frequency of each parameter is comprehended for each activity of the standard flow and each custom flow.

The update frequency difference calculating unit 133 and related parameter identifying unit 134 execute an example of processing for identifying, as a related parameter, a parameter of which difference between the updating frequency as to the standard flow and the updating difference as to multiple custom flows is relatively great. Note that the processing executed by the update frequency difference calculating unit 133 and related parameter identifying unit 134 may be different from the processing described later, as long as the objective is achieved to the same effect.

Specifically, for each activity in each custom flow, the update frequency difference calculating unit 133 calculates the difference between the updating frequency of that activity, and the updating frequency of an activity in the standard flow corresponding to that activity. The term “activity corresponding to that activity” means an activity which is the same as that activity.

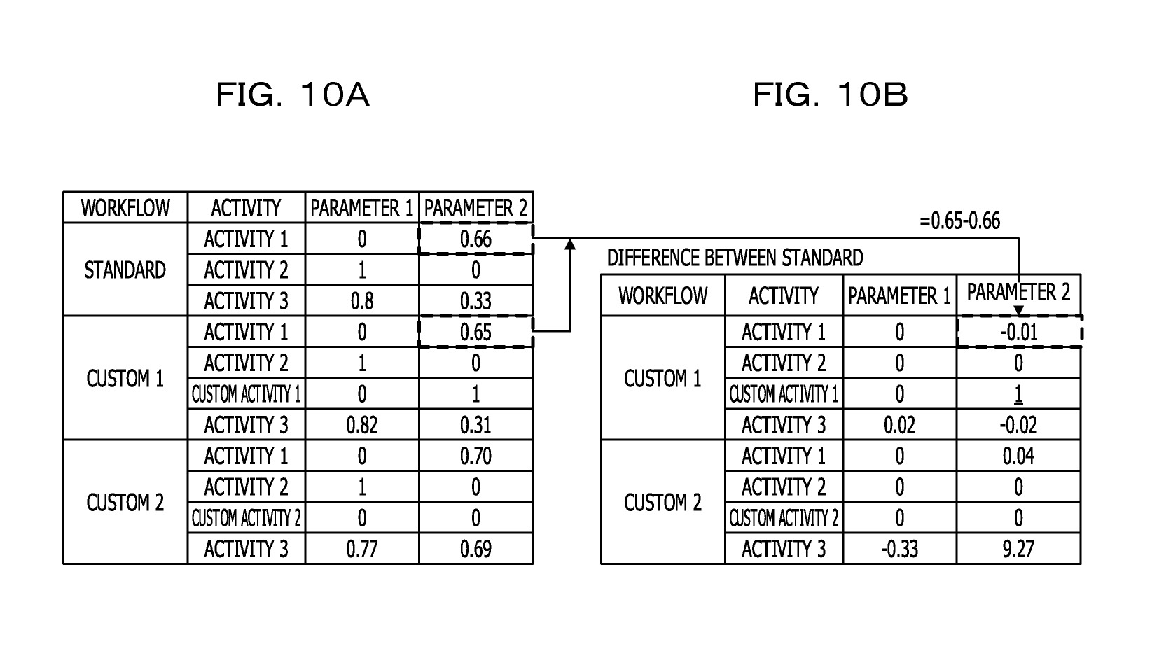

FIGS. 10A and 10B illustrate an example of calculation of difference in updating frequency. FIG. 10A illustrates an example of calculation results for updating frequency of each of the parameters in each of the activities of the standard flow and the two custom flows of custom 1 and custom 2.

FIG. 10B illustrates an example of calculation results of the difference in updating frequency between each of the two custom flows for each activity. For example, as illustrated in FIG. 10A, the updating frequency of parameter 2 as to activity 1 of “custom 1” is 0.65. On the other hand, the updating frequency of parameter 2 as to activity 1 of the standard flow is 0.66. Accordingly, the difference in updating frequency for parameter 2 as to activity 1 of “custom 1” is 0.65−0.66=0.01.

The related parameter identifying unit 134 identifies related parameters from the parameters which the standard flow and each of the custom flows use. That is to say, by the update frequency difference calculating unit 133 calculating the difference in updating frequency, it is comprehended which parameter updating frequency has changed more by customization, for each activity of each custom flow. In other words, it is comprehended which parameter is affected more by customization, for each activity of each custom flow. A parameter affected more by customization is a related parameter. Accordingly, the related parameter identifying unit 134 identifies a parameter with greater difference in updating frequency as being a related parameter, based on the information illustrated in FIG. 10B. In the case in FIG. 10B, the parameter 2 is identified as the related parameter, detailed identifying method being described later.

The related parameter average calculating unit 135 calculates the average value of each parameter value at the time of ending the workflow, for each workflow, from the execution results of the workflow.

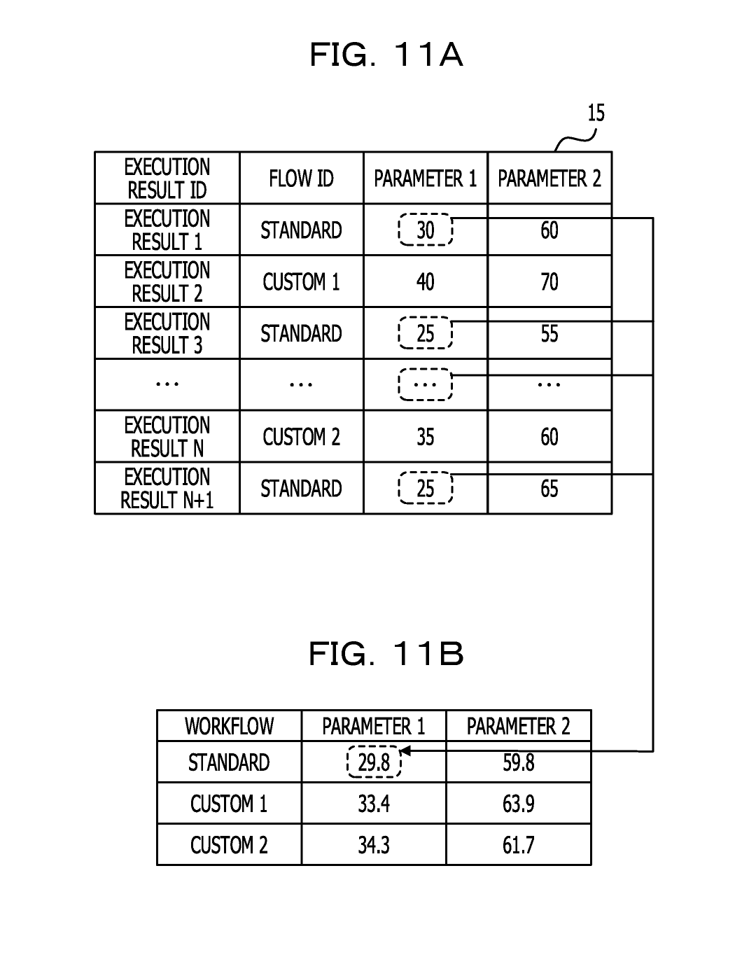

FIGS. 11A and 11B illustrate an example of calculating average values of parameters when a workflow ends. FIG. 11A illustrates an example of information which the parameter value storage unit 15 stores.

FIG. 11B illustrates an example of calculating average values of parameters when a workflow ends. For example, for the parameter 1 of the standard flow, the summation of values of parameter 1 at the time of all execution results ending for the standard flow being divided by the number of execution results (i.e., the number of times of execution of the standard flow) yields the average value. This is performed in the same way for the other parameters and the other workflows.

With regard to the related parameter, the recommended flow selecting unit 136 calculates, for each custom flow, the difference between the average value of each parameter value at the time of ending this custom flow, and average value of each parameter value at the time of ending the standard flow. The recommended flow selecting unit 136 selects the custom flow which has the relatively great difference. The selected custom flow is the recommended flow.

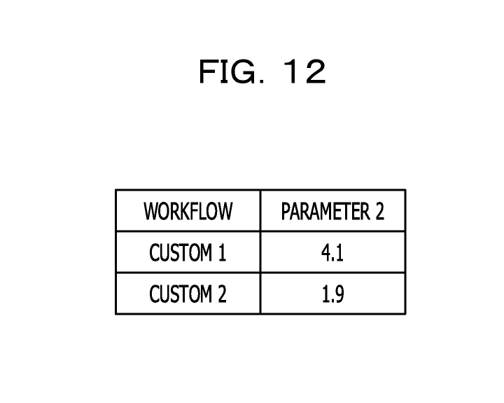

FIG. 12 is a diagram illustrating a calculation example of difference in parameter values when ending the workflow, between each custom flow and the standard flow. FIG. 12 illustrates an example where parameter 2 is the related parameter. Also, the calculation results in FIG. 12 are based on FIG. 11B. That is to say, the difference between “custom 1” and the standard flow with regard to parameter 2 is 63.9−59.8=4.1. Also, the difference between “custom 2” and the standard flow with regard to parameter 2 is 61.7−59.8=1.9.

“Custom 1” has the relatively greater difference. Accordingly, “custom 1” is extracted as the recommended flow.

That is to say, customization is considered to be performed to raise the usage value of the workflow. With the present embodiment, the usage value of the workflow is compared by objectives achievement degree. The objectives achievement degree is an index based on the value of the related parameter. Accordingly, a custom flow with a relatively high usage value is though to have greater change in the value of the related parameter as to the standard flow, as compared with other custom flows. Accordingly, with the present embodiment, a custom flow which has the greatest difference as to the standard flow with regard to the value of the related parameter when each workflow ends, is selected as the recommended flow.

The response returning unit 14 returns a response including the extracting results of the recommended flow by the extracting unit 13 to the workflow managing device 20.

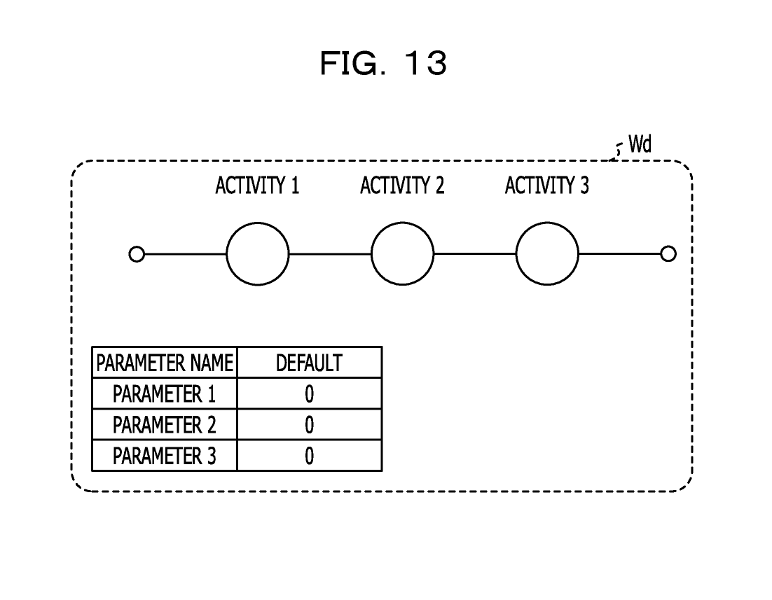

The processing procedures which the workflow extracting unit 10 executes will be described below. The workflow illustrated in FIG. 13 will be used as a specific example of a standard flow in the description of the processing procedures.

FIG. 13 is a diagram illustrating a specific example of a standard flow used for describing processing procedures. As illustrated in FIG. 13, the standard flow Wd includes three activities of activity 1 through 3. The standard flow Wd also uses three parameters of parameter 1 through 3. The initial values of each parameter is 0.

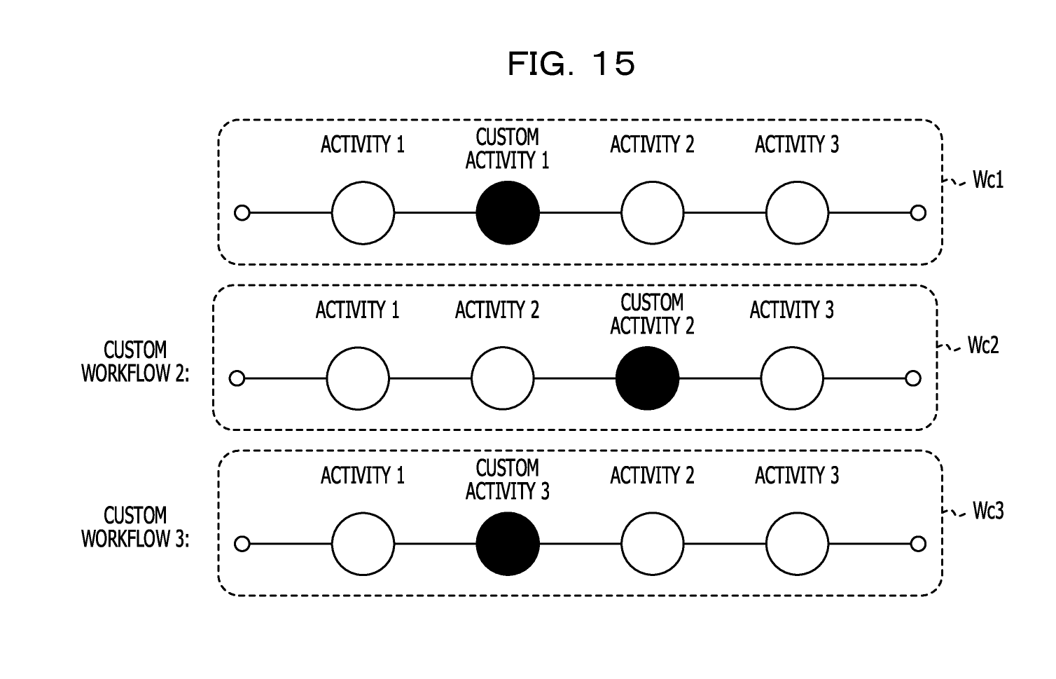

Also, specific examples of custom flows of the standard flow Wd are illustrated in FIG. 15. FIG. 15 is a diagram illustrating a specific example of custom flows used for describing processing procedures. FIG. 15 illustrates custom flows Wc1, Wc2, and Wc3 as an example of custom flows of the standard flow Wd. Note that the white circles in the custom flows indicate activities also included in the standard flow Wd, and the solid circles indicate activities added in that custom flow.

Specifically, with the custom flow Wc1, a custom activity 1 has been added between activity 1 and activity 2. With the custom flow Wc2, a custom activity 2 has been added between activity 2 and activity 3. With the custom flow Wc3, a custom activity 3 has been added between activity 1 and activity 2.

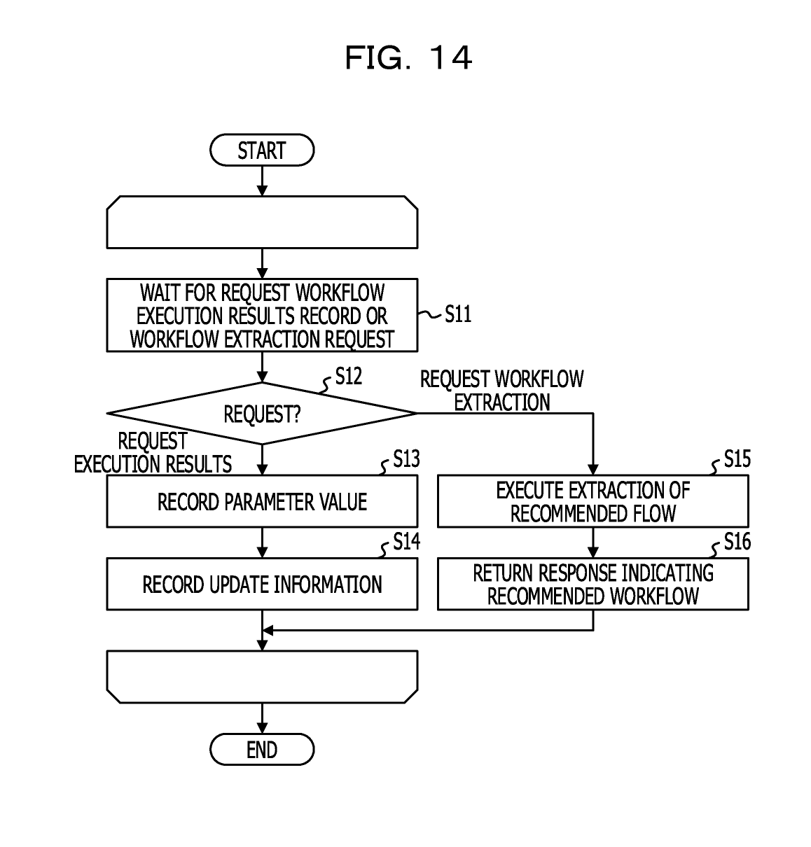

FIG. 14 is a flowchart for describing an example of processing procedures which the workflow extracting device executes.

In step S11, the request reception unit 11 stands by awaiting a recording request for execution results of a workflow from the workflow managing device 20, or a extracting request. Upon receiving either request, the extracting unit 13 branches the processing in accordance with the contents of the request (S12). For example, in the event that a recording request for the execution results of the standard flow Wd has been received, the recording unit 12 records part of the parameter value information specified in the execution results recording request, in the parameter value storage unit 15 (S13).

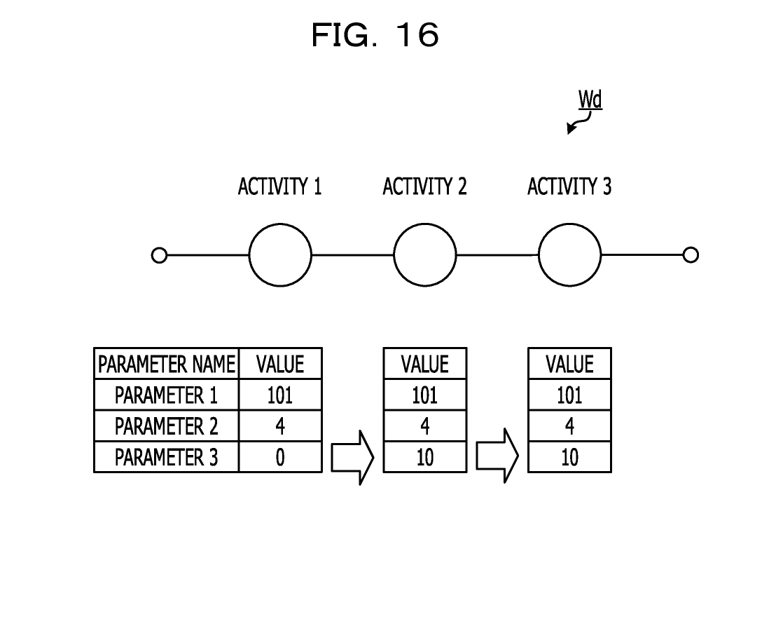

FIG. 16 is a diagram illustrating an example of parameter value information specified in the execution results recording request for the standard activity. FIG. 16 corresponds to a case where a recording request for the execution results of the standard flow Wd has been received. Accordingly, the parameter value information includes values after updating of each parameter in the respective activities of activity 1 through 3 included in the standard flow Wd.

Note the flow diagram illustrating the standard flow Wd in FIG. 16 has been provided for the same of convenience of describing the correlation between each activity and the values of each parameter in that activity after updating. Actually, the value of each parameter in each activity after updating is specified in the recording request, for each activity identifier (hereinafter referred to as “activity ID”). Also, the flow ID of the workflow relating to the execution results is also specified in the recording request.

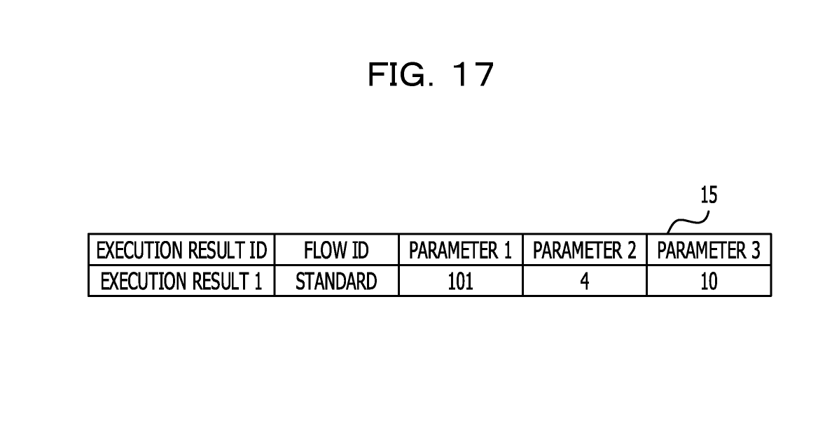

Also, FIG. 17 is a diagram illustrating an example of storing parameter values in a parameter value storage unit. As illustrated in FIG. 17, the parameter value storage unit 15 stores, for each workflow execution results identifier (hereinafter referred to as “execution results ID”), the flow ID of the workflow relating to these execution results, and the parameter values of this workflow at the time of ending. Note that in FIG. 17, “execution results 1” is equivalent to an execution results ID, and “standard” is equivalent to a flow ID. Note that FIG. 17 illustrates, of the parameter value information illustrated in FIG. 16, the parameter values at the time of the standard flow Wd ending, i.e., a state where parameter values as to activity 3 have been recorded.

Continuing, the recording unit 12 records update information based on the parameter value information specified in the execution results recording request, in the update information storage unit 16 (S14).

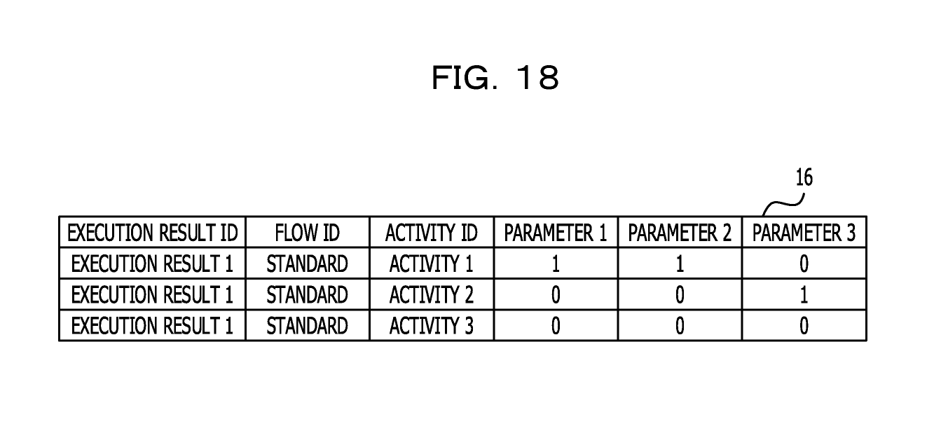

FIG. 18 is a diagram illustrating a storage example of update information at a update information storage unit. As illustrated in FIG. 18, the update information storage unit 16 stores whether or not there has been updating of the parameters, for each workflow execution results and activity. The expression format of whether or not there has been updating is as described with regard to FIG. 8. Note that for activity 1 which is the first activity, the recording unit 12 determines whether or not there has been updating by comparing each parameter value after updating with the initial value of each parameter. For the second and subsequent activities, the recording unit 12 determines whether or not there has been updating by comparing each parameter value after updating with the immediately preceding parameter value after updating. Note that FIG. 18 illustrates update information recorded based on the parameter value information illustrated in FIG. 16.

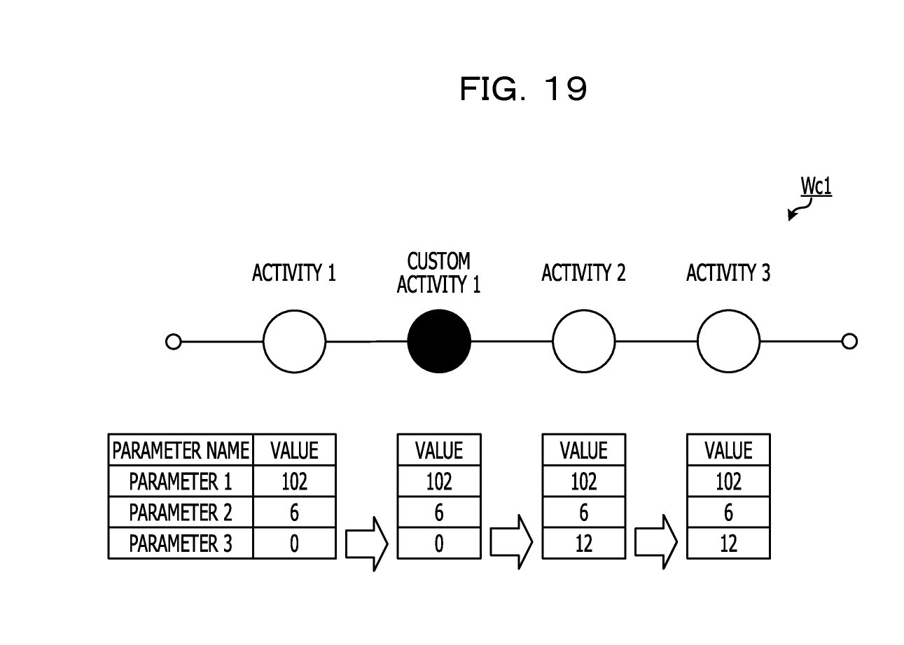

Also, we will say that in step S11, an execution results recording request of the custom flow Wc1, with parameter value information such as illustrated in FIG. 19 specified, has further been received.

FIG. 19 is a diagram illustrating an example of parameter value information specified in the execution results recording request of the custom activity. The configuration of FIG. 19 is the same as that of FIG. 16, so detailed description of FIG. 19 will be omitted. Note that custom flow Wc1 also includes custom activity 1, so the parameter value information also includes the values of each parameter after updating due to the custom activity 1.

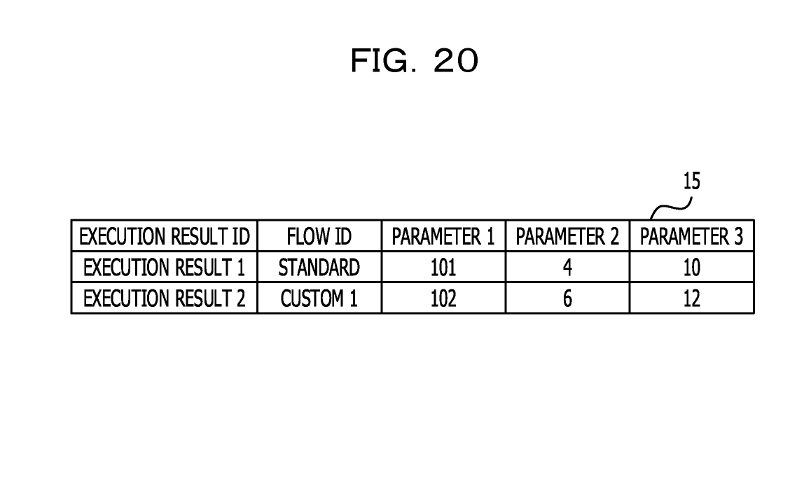

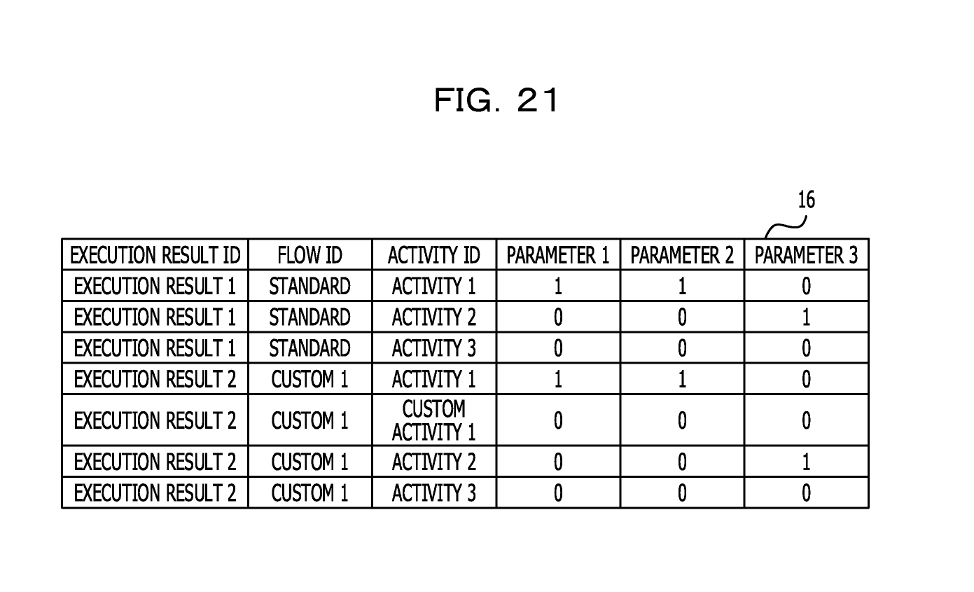

The parameter value storage unit 15 or update information storage unit 16 illustrated in FIGS. 17 and 18 is updated as illustrated in FIG. 20 or 21, based on the parameter value information illustrated in FIG. 19.

FIG. 20 is a diagram illustrating an updated example of a parameter value storage unit. The parameter value storage unit 15 illustrated in FIG. 20 is the parameter value storage unit 15 illustrated in FIG. 17 with the second row of records, of which the execution results ID is “execution results 2”, added thereto. The records of the second row have stored therein, of the parameter value information illustrated in FIG. 19, the parameter values of the custom flow Wc1 at the time of ending.

FIG. 21 is a diagram illustrating a updating example of an update information storage unit. The update information storage unit 16 illustrated in FIG. 21 has added thereto four rows worth of records of which the execution results ID is “execution results 2” and the flow ID is “custom 1”. These records have recorded therein update information based on the parameter value information illustrated in FIG. 19.

On the other hand, in the event that no workflow extracting request has been received, the extracting unit 13 executes recommended flow extracting processing (S15). Note that the workflow extracting request has specified therein the flow ID of the standard flow to which the custom flow to be extracted corresponds, for example. Hereinafter, a standard flow of which the flow ID has been specified in a workflow extracting request will be referred to as a “reference flow”. With the present embodiment, the standard flow Wd serves as the reference flow. Next, the response returning unit 14 returns a response including information indicating the extracted recommended flow to the workflow managing device 20 (S16). For example, the flow ID of the recommended flow is an example of information indicating the recommended flow.

After step S14 or S16 ending, the flow stands by to receive the next request (S11).

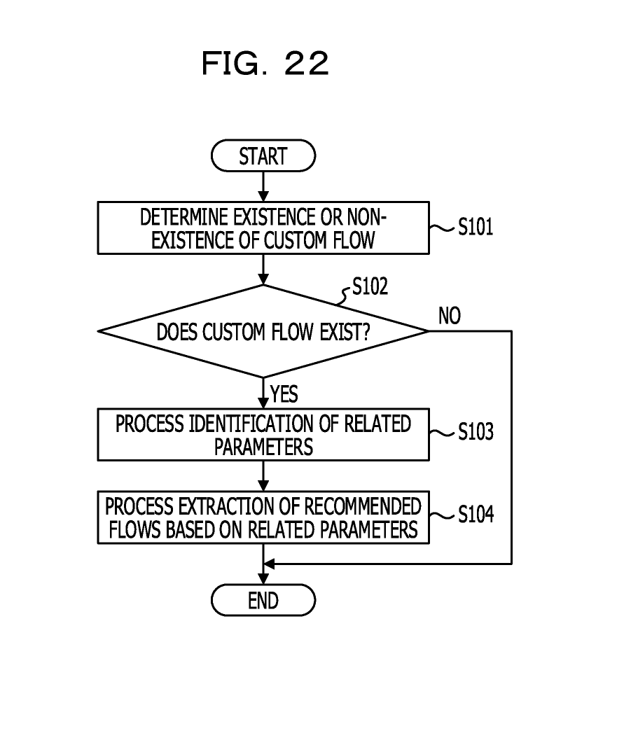

Next, step S15 will be described in detail. FIG. 22 is a diagram illustrating an example of processing procedures for extracting processing of a recommended flow.

In step S101, the extracting unit 13 determines whether or not a record of a custom flow as to the reference flow has been stored in the parameter value storage unit 15. That is to say, whether or not a record including a flow ID of the custom flow is stored in the parameter value storage unit 15 is determined.

The method for identifying a custom flow as to the reference flow is not restricted to any particular arrangement. For example, the extracting unit 13 may specify the flow ID of the reference flow and query the workflow managing device 20 for a list of flow IDs of the custom flows of the reference flow relating to that flow ID. Alternatively, information indicating the parent-child relationship of each workflow may be stored in the workflow extracting unit 10. Further, the flow IDs of each custom flow corresponding to the reference flow may be specified in the workflow extracting request, not just the flow ID of the reference flow.

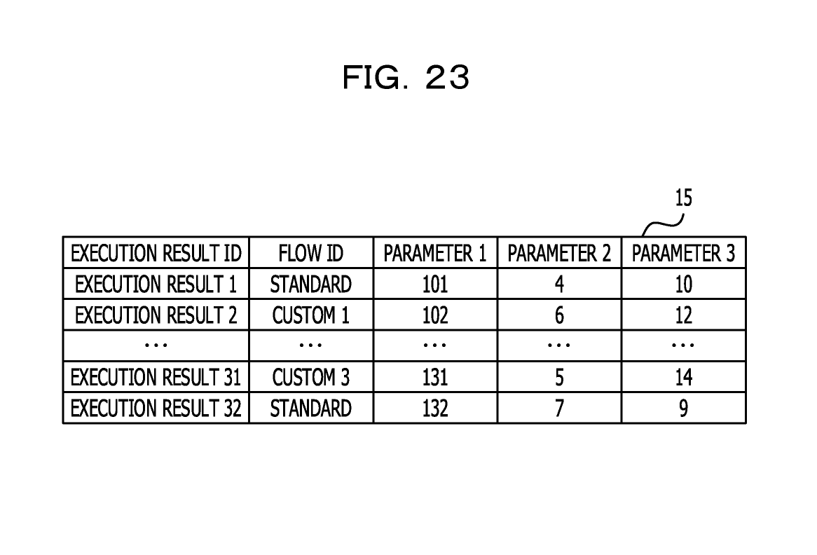

Note that the state of the parameter value storage unit 15 at the point of having received the workflow extracting request is as illustrated in FIG. 23.

FIG. 23 is a diagram illustrating an example of a state of the parameter value storage unit when extracting a recommended flow. Stored in the parameter value storage unit 15 in FIG. 23 is parameter value information relating to execution results 1 through 32. Each of execution results 1 through 32 are execution results of one of standard flow Wd or custom flow Wc1 through Wc3.

In the event that there are not custom flow records corresponding to the reference flow recorded in the parameter value storage unit 15 (No in step S102), no extractable recommended flows exists, so the extracting processing ends.

With the example in FIG. 23, there are custom flow records corresponding to the reference flow recorded in the parameter value storage unit 15 (Yes in step S102), so the flow advances to step S103. In step S103, the extracting unit 13 executes related parameter identifying processing. Subsequently, the extracting unit 13 executes extracting processing of the recommended flow based on the related parameter (S104).

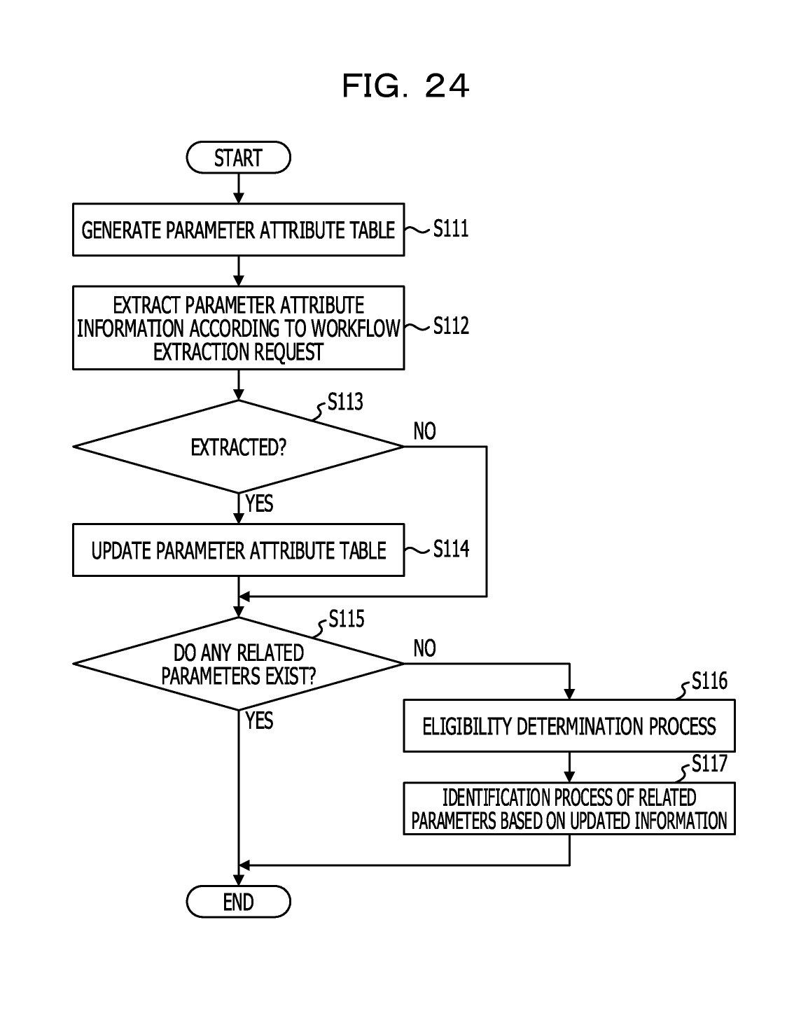

Next, the processing of step S103 will be described in detail. FIG. 24 is a flowchart illustrating an example of processing procedures for related parameter identifying processing.

in step S111, the parameter excluding unit 131 generates a parameter attribute table 171, corresponding to the standard flow relating to the flow ID specified in the workflow extracting request (hereinafter referred to simply as “extracting request”) and the custom flows of the standard flow, in the calculation table storage unit 17.

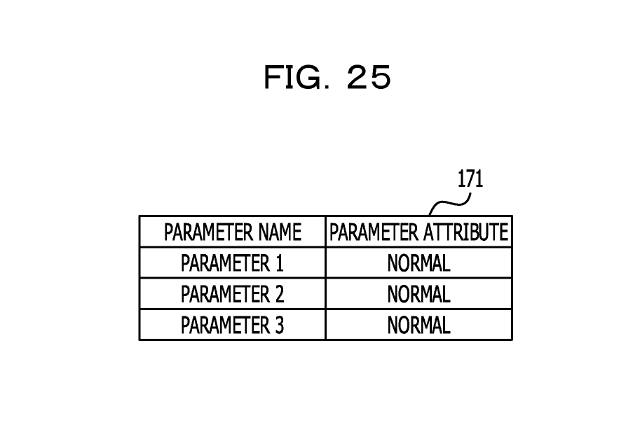

FIG. 25 is a diagram illustrating a configuration example of a parameter attribute table. The parameter attribute table 171 is a table storing parameter names and parameter attributes for each parameter used by the standard flow Wd specified in the extracting request of the workflow and the custom flows of the standard flow Wd (hereinafter referred to as “used parameter”).

The term parameter attribute means information indicating how each parameter is to be handled in identifying processing of the related parameter. With the present embodiment, “normal”, “excluded”, “candidate”, and “related” are available.

“Normal” means that no special treatment is given. “Excluded” means exclusion from candidates for the related parameter. “Candidate” means to not exclude from candidates for the related parameter, even if meeting exclusion standards as a candidate for the related parameter. “Related” means to take as the related parameter.

At the stage of step S111, the parameter name of each used parameter is recorded in the newly-generated parameter attribute table 171. Also, “normal” is recorded as the initial value of parameter attributes for the used parameters, as indicated in FIG. 25.

Next, the parameter excluding unit 131 extracts parameter attribute information which may be specified in the extracting request from the extracting request (S112). The term parameter attribute information means information regarding which parameter attributes have been specified for all or part of the used parameters. That is to say, with the present embodiment, parameter attributes may be specified for all or part of the used parameters by the workflow managing device 20. For example, in the event that the workflow managing device 20 knows all or part of the parameter attribute information, this may be specified in the extracting request. Accordingly, this means that the parameter attribute information may not be specified in the extracting request.

In the event that parameter attribute information is extracted from the extracting request (Yes in S113), the parameter excluding unit 131 updates the parameter attribute table 171 based on the contents of the parameter attribute information (S114). For example, if there is a parameter regarding which “excluded”, “candidate”, or “related” has been specified, the value of that parameter attribute in the parameter attribute table 171 is updated to “excluded”, “candidate”, or “related”.

Next, the parameter excluding unit 131 determines whether or not the value of parameter attributes in the parameter attribute table 171 is “related” (S115). In the event that there is a parameter that meets this (Yes in S115), the processing of FIG. 24 ends. That is to say, this parameter is identified as being a related parameter.

In the event that there is no parameter that meets this (No in S115), the parameter excluding unit 131 executes determining processing regarding suitability as a related parameter (S116). In this suitability determining processing, part of the parameters are excluded from related parameter candidates.

Next, the extracting unit 13 executes related parameter identifying processing based on the information stored in the update information storage unit 16 (S117). Step S117 is executed relating to used parameters not excluded from being related parameter candidates.

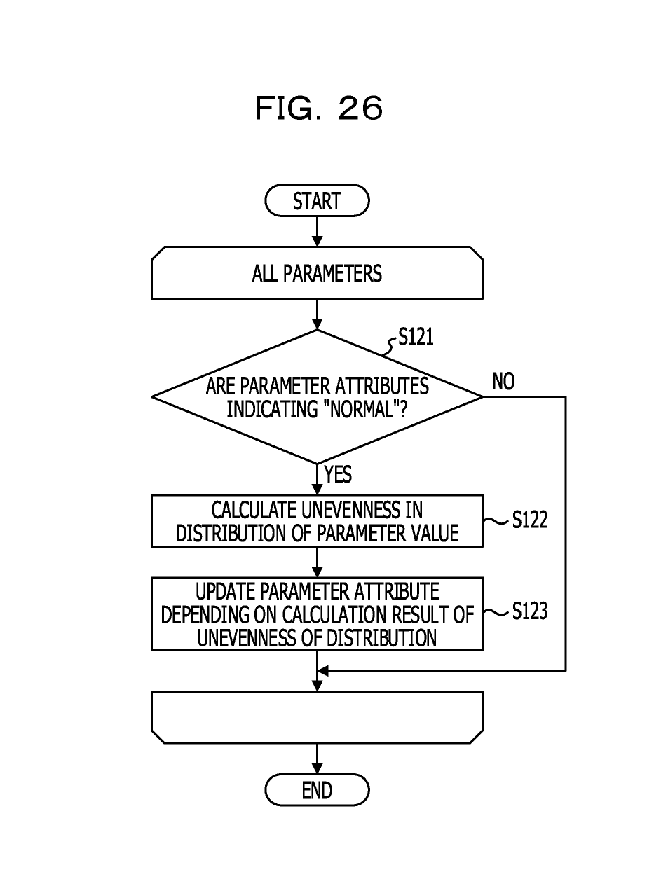

Next, step S116 will be described in detail. FIG. 26 is a flowchart for describing an example of processing procedures for suitability determining processing for being a related parameter. Step S121 and thereafter is loop processing for each used parameter (parameters 1 through 3). A parameter which is the object of processing in this loop processing will be referred to as “object parameter”.

In step S121, the parameter excluding unit 131 references the parameter attribute table 171 and determines whether the parameter attribute of the object parameter is “normal”. In the event that the parameter attribute of the object parameter is not “normal” (No in step S121), steps S122 and S123 are not executed for this object parameter.

In the event that the parameter attribute of the object parameter is “normal” (Yes in step S121), the parameter excluding unit 131 calculates the unevenness in distribution of the value of the object parameter in the parameter value storage unit 15 (FIG. 23) (S122). For example, in the event that the object parameter is 1, unevenness in distribution of the value of the parameter 1 is calculated throughout the standard flow Wd and each custom flow. That is to say, with the example in FIG. 23, the unevenness in distribution of the values stored in the column for “parameter 1” (101, 102, . . . , 131, 132) is calculated.

Next, in the event that the calculated unevenness in distribution is a uniform distribution, or concentrated on a single value (i.e., constantly the same), the parameter excluding unit 131 updates the value of this parameter attribute in the parameter attribute table 171 to “excluded” (S123). The reason is that, an object parameter which is serial in the order of execution results is likely nothing more than a sequence number. Also, an object parameter which concentrates on a single value is likely a constant or a fixed value. Such parameters are considered to have little likelihood of being related to objectives achievement. Accordingly, in the event that the unevenness in distribution is a uniform distribution or concentrated on a single value, such object parameters are excluded from being a related parameter candidate.

Note that any known method may be used to calculate the unevenness in distribution. For example, determination may be made that a uniform distribution if all instances of a parameter value are the same, or may be made that a uniform distribution if the Iδ index is obtained and found to be smaller than 1.

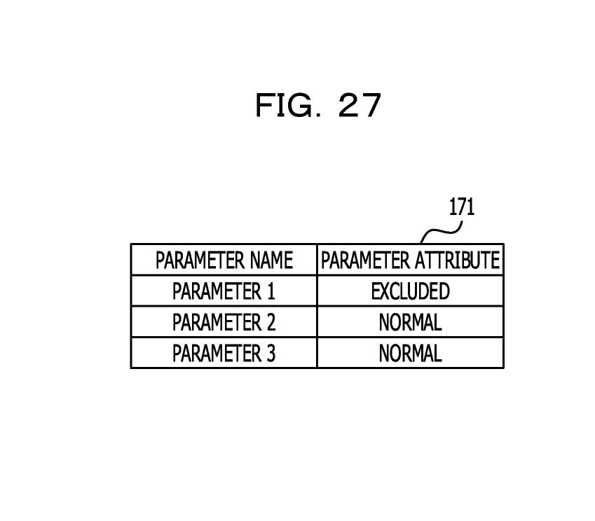

With the present embodiment, at the time of ending FIG. 26, the state of the parameter attribute table 171 has been updated such as illustrated in FIG. 27.

FIG. 27 is a diagram illustrating an updated example of the parameter attribute table. As illustrated in FIG. 23, the distribution of the value of parameter 1 is uniform. Accordingly, as illustrated in FIG. 27, the parameter attribute of parameter 1 has been updated to “excluded”. Note that hereinafter, used parameters which are the object of processing are parameters other than those of which the parameter attribute is “excluded”. Hereinafter, a used parameter other than one of which the parameter attribute is “excluded” is called a “candidate parameter”.

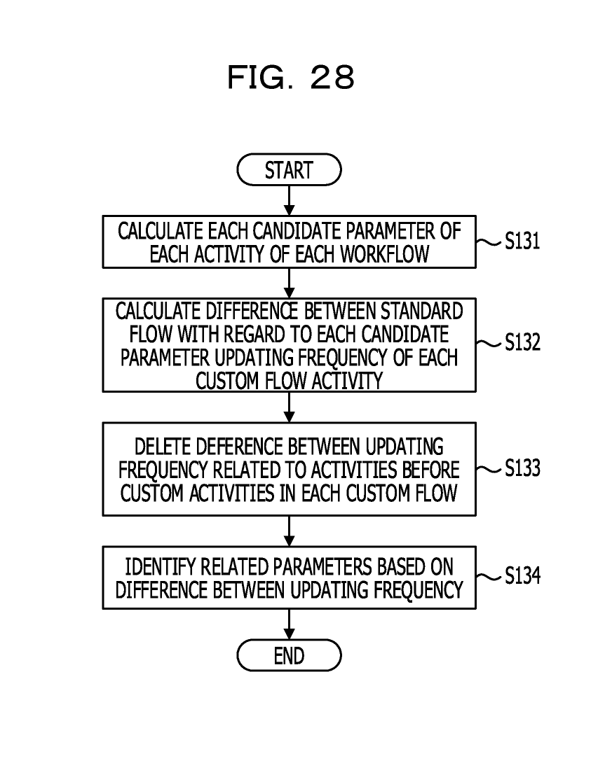

Next, step S117 in FIG. 24 will be described in detail. FIG. 28 is a flowchart describing an example of processing procedures for related parameter identifying processing, based on the update information.

In step S131, the update frequency calculating unit 132 calculates the updating frequency of each candidate parameter with regard to each activity in the standard flow Wd and the custom flows Wc1 through Wc3, based on the information stored in the update information storage unit 16. That is to say, the processing described with FIG. 9 is executed on each of the standard flow Wd and the custom flows Wc1 through Wc3. The calculation results are recorded in an updating frequency table 172. The updating frequency table 172 is generated in the calculation table storage unit 17, for example.

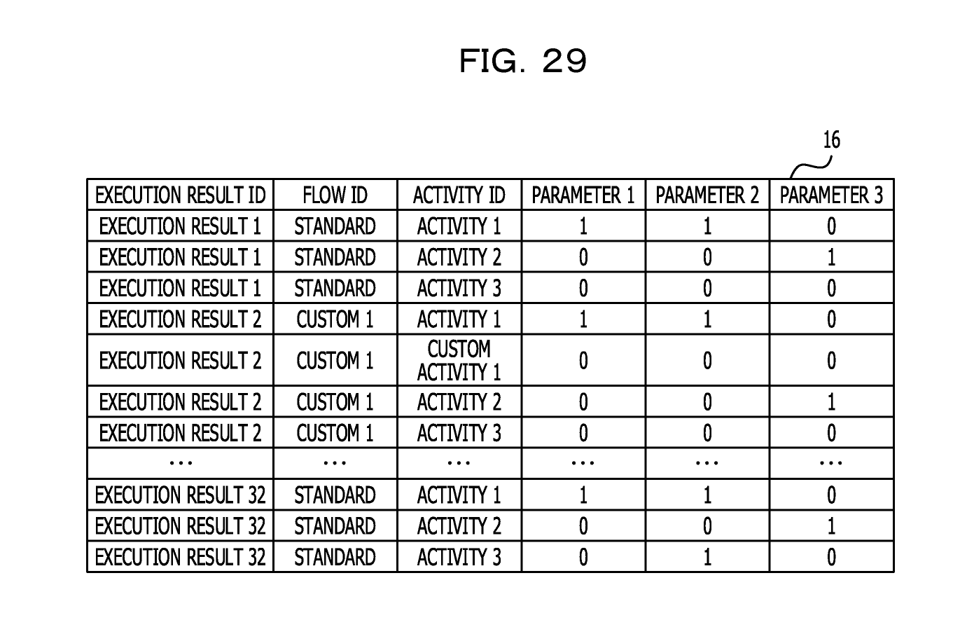

For example, the update information storage unit 16 corresponding to the parameter value storage unit 15 in FIG. 23 is as illustrated in FIG. 29. FIG. 29 is a diagram illustrating an example of the state of the update information storage unit when extracting a recommended flow. The configuration of the update information storage unit 16 illustrated in FIG. 29 is as described with FIG. 18. FIG. 29 differs from FIG. 18 with regard to the point that update information is stored regarding multiple execution results.

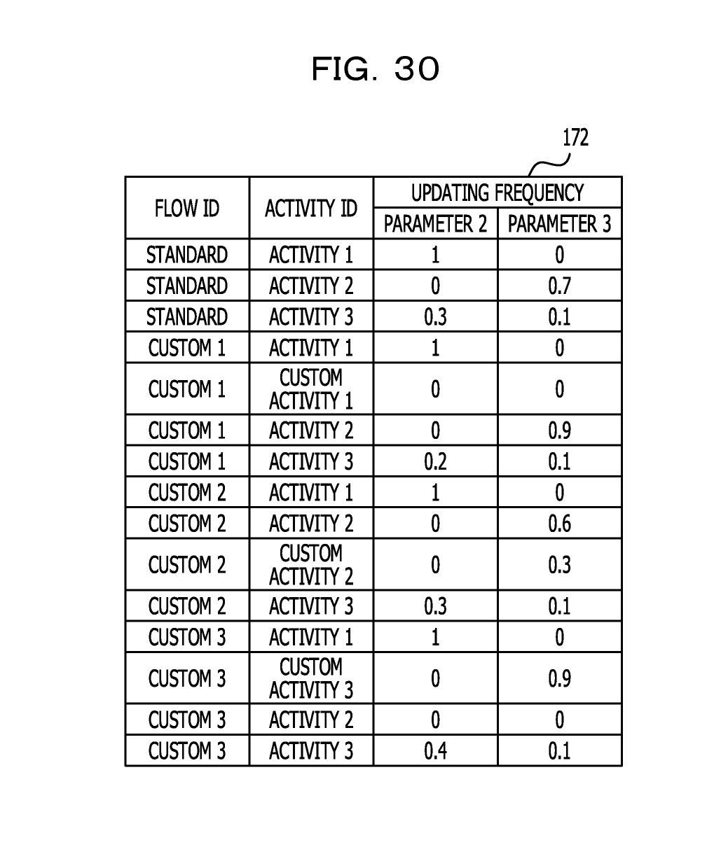

For example, in step S131, the updating frequency table 172 illustrated in FIG. 30 is generated based on the update information storage unit 16 illustrated in FIG. 29.

FIG. 30 is a diagram illustrating a specific example of an updating frequency table. The updating frequency table 172 is a table storing the updating frequency of each parameter for each activity of the standard flow Wd and custom flows Wc1 through Wc3.

Next, the update frequency difference calculating unit 133 references the updating frequency table 172 and calculates, for each activity of the custom flows Wc1 through Wc3, the difference between the updating frequency of each candidate parameter in this activity, and the updating frequency of each candidate parameter in the activity in the standard flow Wd which corresponds to this activity (S132). That is to say, the processing described with FIG. 10 is executed regarding each of custom flows Wc1 through Wc3. The execution results are recorded in a updating frequency difference table 173. The updating frequency difference table 173 is generated in the calculation table storage unit 17, for example.

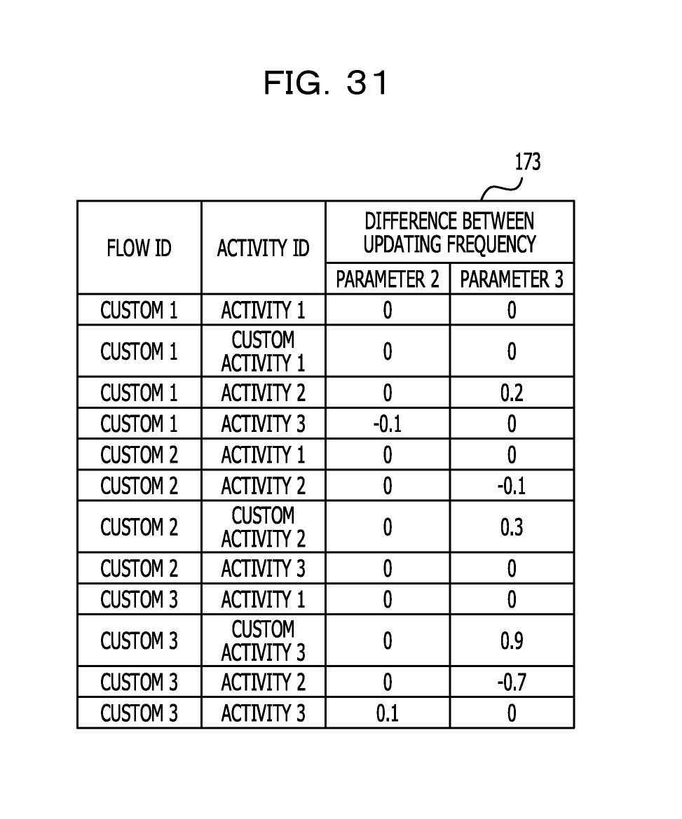

For example, in step S132, the updating frequency difference table 173 illustrated in FIG. 31 is generated based on the updating frequency table 172 illustrated in FIG. 30.

FIG. 31 is a diagram illustrating a configuration example of a updating frequency difference table. As illustrated in FIG. 31, the updating frequency difference table 173 is a table to store, for each activity of the custom flows Wc1 through Wc3, the difference between the updating frequency of each candidate parameter in this activity, and the updating frequency of each candidate parameter in the activity in the standard flow Wd which corresponds to this activity. With the present embodiment, parameter 1 has been excluded from being a candidate parameter, so in FIG. 31, the difference in updating frequency is illustrated regarding parameters 2 and 3.

Next, the related parameter identifying unit 134 deletes, for each custom flow, difference in updating frequency relating to activities earlier than the custom activity of this custom flow, from the updating frequency difference table 173 (S133).

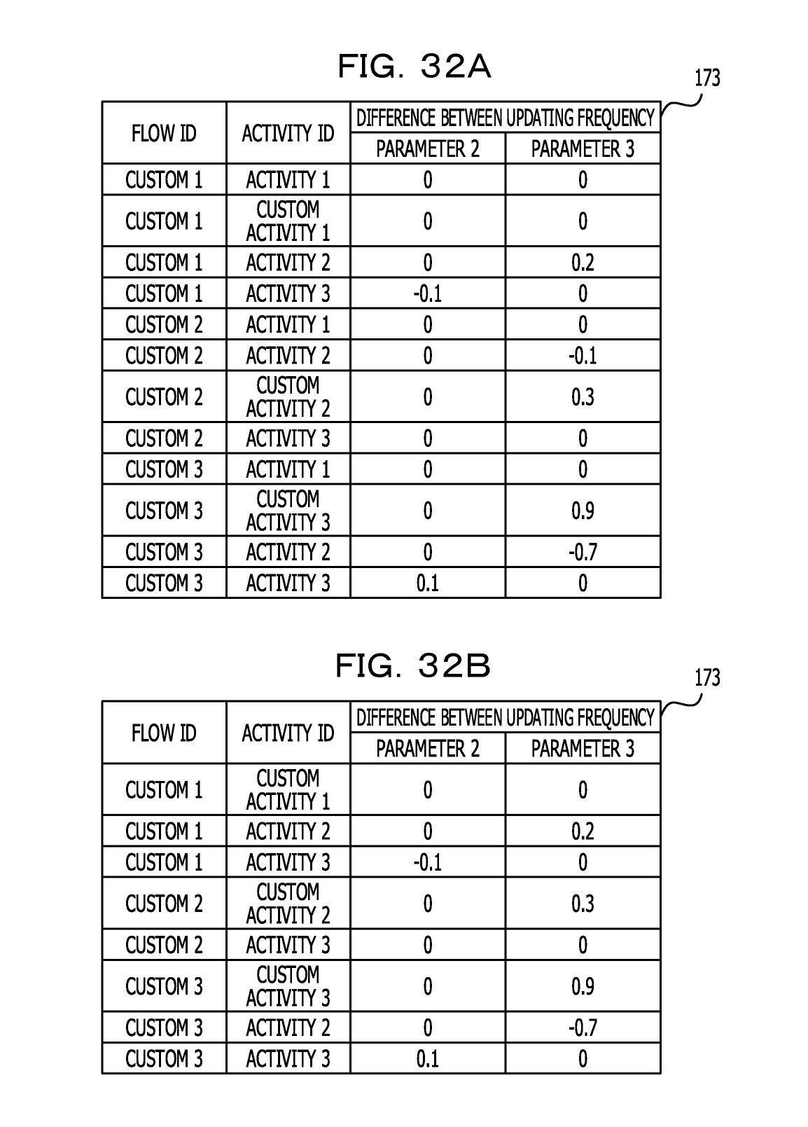

FIGS. 32A and 32B illustrate an example of deleting difference of updating frequency relating to activity earlier than the custom activity. FIG. 32A is an updating frequency difference table 173 before deleting, and FIG. 32B is an updating frequency difference table 173 after deleting. In FIG. 32B, with regard to custom flow Wc1 (“custom 1”), records relating to activity 1 (see FIG. 15) before the custom activity 1 have been deleted. Also, with regard to custom flow Wc2 (“custom 2”), records relating to activities 1 and 2 (see FIG. 15) before the custom activity 2 have been deleted. Further, with regard to custom flow Wc3 (“custom 3”), records relating to activity 1 (see FIG. 15) before the custom activity 3 have been deleted. Due to this deletion of these records, in subsequent processing, in each custom flow, activities after the custom activity are taken as objects of processing.

Note that step S133 may not be executed. Also, only activities after the custom activity may be set as objects of processing for the custom flows Wc1 through Wc3 in step S131. In this case step S133 does not have to be executed.

Next, the related parameter identifying unit 134 identifies related parameters based on the difference in updating frequency not deleted in step S133 (S134). That is to say, related parameters are identified based on the difference in updating frequency regarding activities after the custom activity. Normally, it is thought that change in a custom flow will occur as to the standard flow after the custom activity. Accordingly, by taking the difference in updating frequency regarding activities after the custom activity as the object of processing, the custom activities may be compared with regard to the portions where change occurs as to the standard flow.

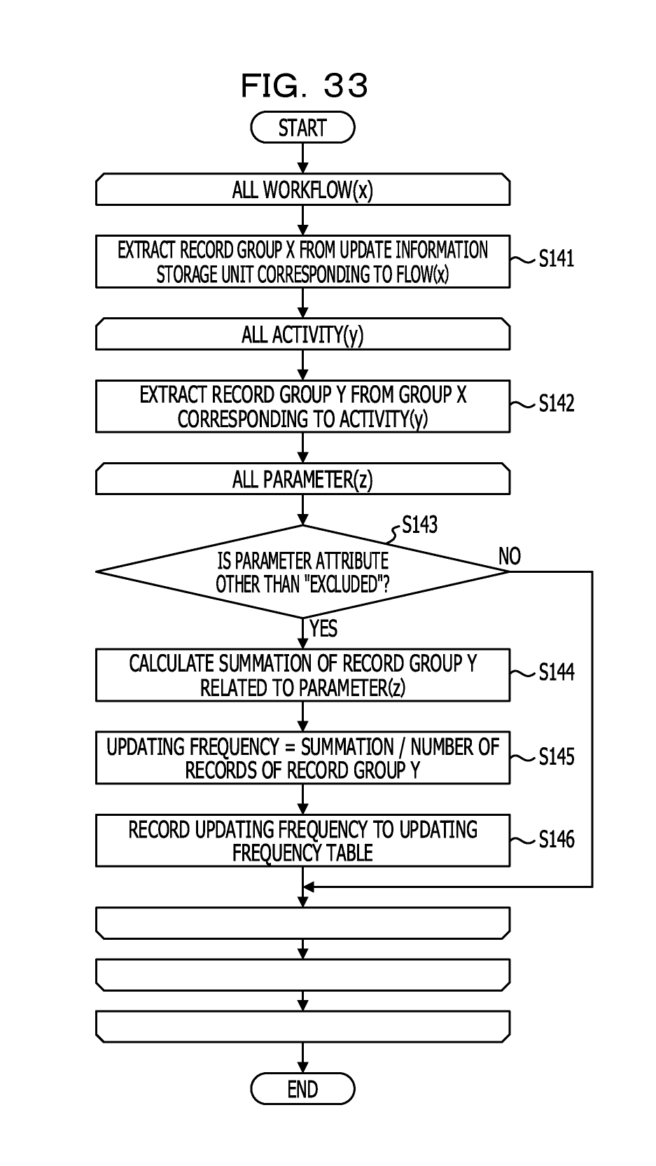

Next, step S131 will be described in detail. FIG. 33 is a flowchart for describing an example of processing procedures for updating frequency calculating processing of the candidate parameters relating to each activity of each workflow. In FIG. 33, three loops are nested. The outermost loop is a loop x for each standard flow Wd and custom flows Wc1 through Wc3. Workflows to be processed in loop x will be called “flow (x)”. The loop one inside the loop x is a loop y of each activity included in flow (x). activities to be processed in loop y will be called “activity (y)”. The inner most loop is a loop z of each used parameter parameters to be processed in loop z will be called “parameter (z)”.

In loop x, upon one of the standard flow Wd and custom flows Wc1 through Wc3 being taken as flow (x), the update frequency calculating unit 132 extracts a record group X corresponding to the flow (x) from the update information storage unit 16 (FIG. 29) (S141). For example, in the event that the standard flow Wd is the flow (x), a record group X of which the flow ID is “normal” is extracted from the update information storage unit 16 illustrated in FIG. 29.

Next, in loop y, upon one activity included in the flow (x) being taken as activity (y), the update frequency calculating unit 132 extracts a record group Y corresponding to the activity (y) from the record group X (S142).

Next, in the event of one of the used parameters in loop z being taken as parameter (z), the update frequency calculating unit 132 determines whether or not the value of the parameter attribute of the parameter (z) is “excluded”, by referencing the parameter attribute table 171 (FIG. 27) (S143). In the event that the value of the parameter attribute of the parameter (z) is not “excluded” (Yes in S143), the update frequency calculating unit 132 calculates the summation of the values (“1” or “0”) stored for each record in the record group Y regarding the parameter (z) (S144).

Next, the update frequency calculating unit 132 divides the summation that has been calculated by the number of records included in the record group Y, thereby calculating the updating frequency of the parameter (z) (S145). Next, the update frequency calculating unit 132 records the calculated updating frequency in the item corresponding to the parameter (z) in the record corresponding to flow (x) and activity (y) in the updating frequency table 172 (FIG. 30) (S146).

On the other hand, in the event that the value of the parameter attribute of the parameter (z) is “excluded” (No in S143), steps S144 through S146 are not executed.

Due to the above processing being executed for each used parameter of each activity in each workflow, the updating frequency table 172 illustrated in FIG. 30 is completed.

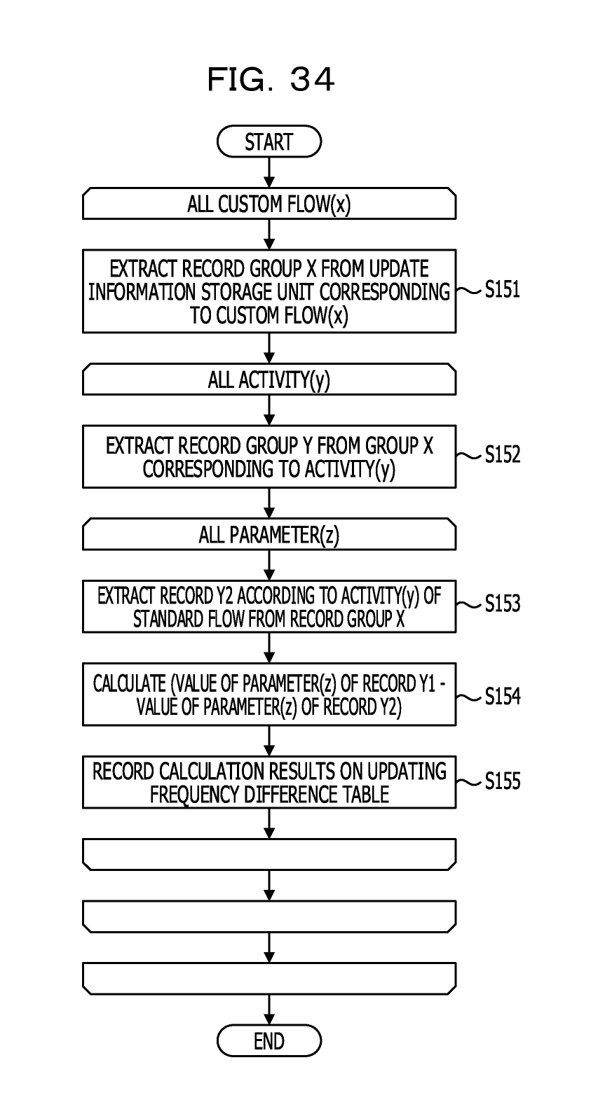

Next, step S132 in FIG. 28 will be described in detail. FIG. 34 is a flowchart for describing an example of processing procedures for calculating processing of the difference between the updating frequency of the candidate parameters of each custom flow and the updating frequency of the candidate parameters of the standard flow. In FIG. 34, three loops are nested. The outermost loop is a loop x for each custom flow Wc1 through Wc3. Custom flows to be processed in loop x will be called “custom flow (x)”. The loop one inside the loop x is a loop y of each activity included in custom flow (x). Activities to be processed in loop y will be called “activity (y)”. The inner most loop is a loop z of each candidate parameter. Parameters to be processed in loop z will be called “parameter (z)”.

In loop x, upon one of the custom flows Wc1 through Wc3 being taken as custom flow (x), the update frequency difference calculating unit 133 extracts a record group X corresponding to the custom flow (x) from the updating frequency table 172 (FIG. 30) (S151). For example, in the event that the custom flow Wc1 is the custom flow (x), a record group X of which the flow ID is “custom 1” is extracted from the updating frequency table 172 illustrated in FIG. 30.

Next, in loop y, upon one activity included in the custom flow (x) being taken as activity (y), the update frequency difference calculating unit 133 extracts a record Y1 corresponding to the activity (y) from the record group X (S152). Next, the update frequency difference calculating unit 133 extracts, for the standard flow Wd, a record Y2 corresponding to the activity (y) from the updating frequency table 172 (FIG. 30) (S153). For example, in the event that activity 1 is the activity (y), the record of the standard flow corresponding to activity 1 is extracted as record Y2. Note that in the event that the activity (y) is a custom activity, there is no corresponding activity in the standard flow. Accordingly, in this case, no record Y2 is extracted in step S153.

Next, in the event of one of the candidate parameters in loop z being taken as parameter (z), the update frequency difference calculating unit 133 subtracts the updating frequency of the parameter (z) in the record Y2 from the updating frequency of the parameter (z) in the record Y1 (S154). The subtraction result is the difference in updating frequency. Note that in the event that record Y2 has not be extracted, the updating frequency of the parameter (z) in the record Y1 serves as the difference in updating frequency for step S154 as it is.

Next, the update frequency difference calculating unit 133 records the calculated difference in updating frequency in the item corresponding to the parameter (z) in the record corresponding to custom flow (x) and activity (y) in the updating frequency difference table 173 (FIG. 31) (S155).

Due to the above processing being executed for each candidate parameter of each activity in each workflow, the updating frequency difference table 173 illustrated in FIG. 31 is completed.

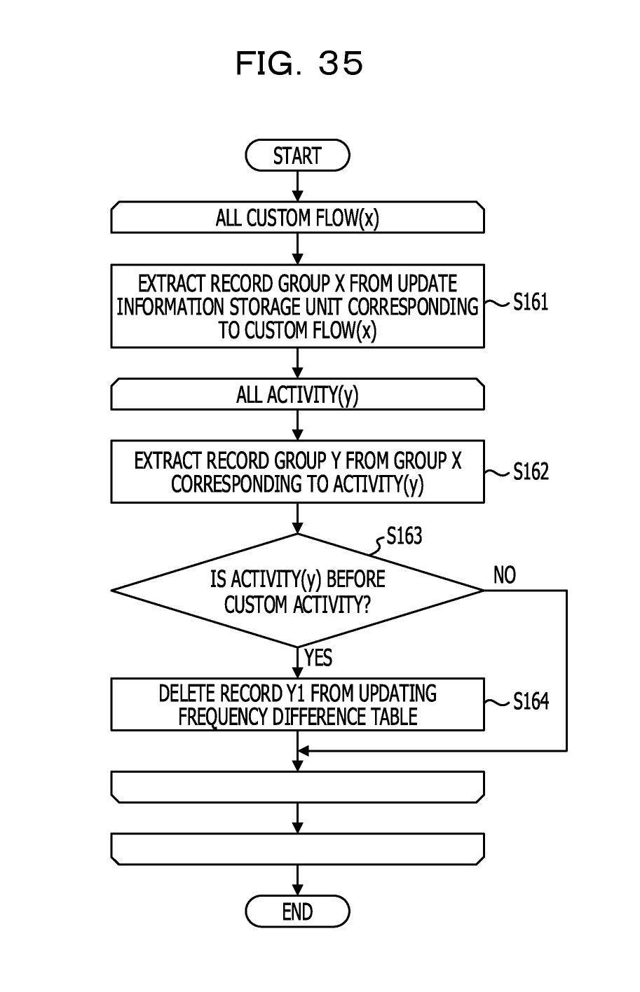

Next, step S133 in FIG. 28 will be described in detail. FIG. 35 is a flowchart for describing an example of processing procedures for deleting processing of difference in updating frequency relating to activities earlier than custom activities. In FIG. 35, two loops are nested. The outer loop is a loop x for each custom flow Wc1 through Wc3. Custom flows to be processed in loop x will be called “custom flow (x)”. The inner loop is a loop y of each activity included in custom flow (x). Activities to be processed in loop y will be called “activity (y)”.

In loop x, upon one of the custom flows Wc1 through Wc3 being taken as custom flow (x), the related parameter identifying unit 134 extracts a record group X corresponding to the custom flow (x) from the updating frequency difference table 173 (FIG. 31) (S161).

Next, in loop y, upon one activity included in the custom flow (x) being taken as activity (y), the related parameter identifying unit 134 extracts a record Y1 corresponding to the activity (y) from the record group X (S162). Next, the related parameter identifying unit 134 determines whether or not the activity (y) is an activity executed earlier than any of the custom activities in the custom flow (x) (S163). The order of execution of each activity may be determined by referencing the updating frequency difference table 173. The reason is that with the present embodiment, updating frequency difference table 173 has stored the records in order of executing of the activities. Alternatively, the definition of the flow (x) may be obtained from the workflow managing device 20, and the relation of before and after between the activity (y) and one of the custom activities may be determined based on this definition.

In the event that the activity (y) is an activity executed earlier than one of the custom activities (Yes in S163), the related parameter identifying unit 134 deletes the record Y1 from the updating frequency difference table 173 (S164). On the other hand, in the event that the activity (y) is a custom activity, or is an activity executed after the custom activities (No in S163), step S164 is not executed.

Due to the above processing being executed for each activity in each custom flow, the updating frequency difference table 173 is updated as illustrated in FIG. 32B.

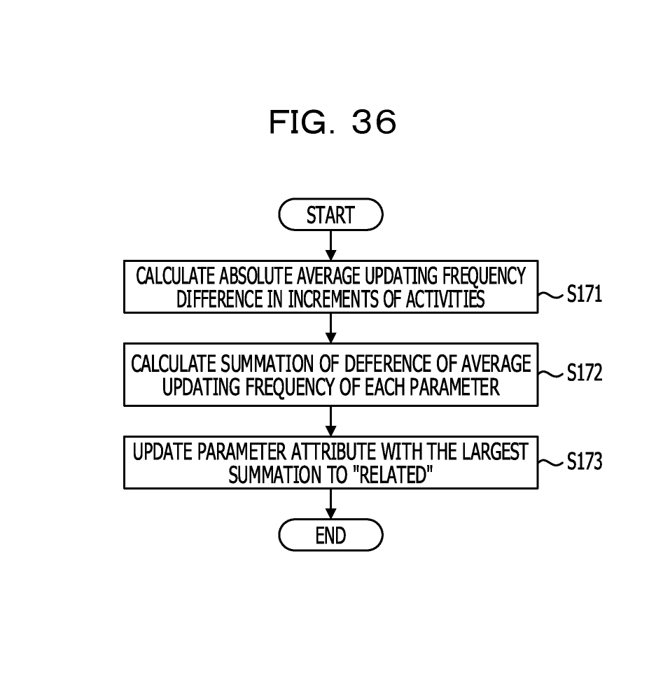

Next, step S134 in FIG. 28 will be described in detail. FIG. 36 is a flowchart for describing an example of processing procedures for related parameter identifying processing based on the difference in updating frequency.

In step S171, the related parameter identifying unit 134 calculates the average of absolute values of the difference in updating frequency in increments of activities (S171).

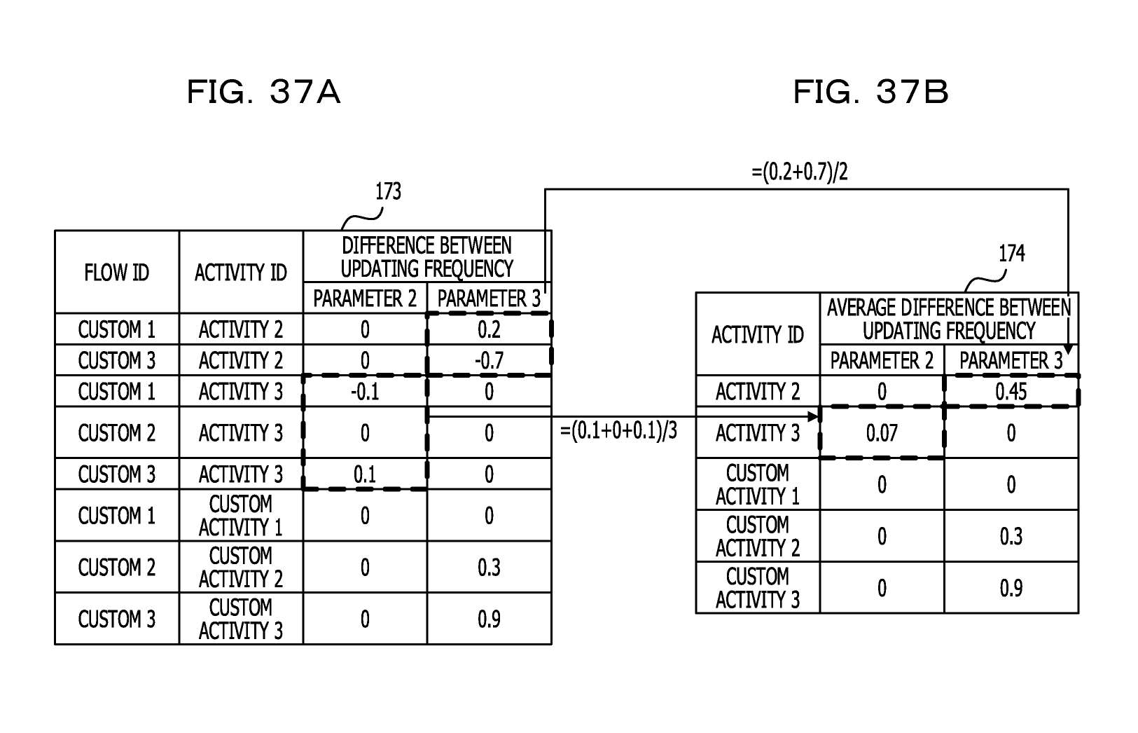

FIGS. 37A and 37B are diagrams illustrating a calculation example of the average in absolute values in difference of updating frequency in increments of activities. FIG. 37A illustrates the updating frequency difference table 173 in FIG. 32B sorted based on activities. FIG. 37B illustrates an average updating frequency difference table 174 in which the calculation results of the average of difference in updating frequency in activity increments is recorded. The average updating frequency difference table 174 is generated in the calculation table storage unit 17, for example.

FIGS. 37A and 37B illustrate an example of calculating the average of absolute values of difference in updating frequency, regarding parameter 3 related to activity 2 and parameter 2 related to activity 3. For example, in the case of the former, the average of absolute values of the values stored as differences in updating frequency of parameter 3 is calculated for activity 2 in all custom flows. Also, in the case of the latter, the average of absolute values of the values stored as differences in updating frequency of parameter 2 is calculated for activity 3 in all custom flows. That is to say, the average of difference in updating frequency in increments of activities means the average of absolute values of difference in updating frequency for each candidate parameter in each same activity. The average of absolute values of difference in updating frequency will hereinafter be referred to as “average updating frequency difference”.

Next, the related parameter identifying unit 134 calculates the summation of average updating frequency difference for each candidate parameter (S172).

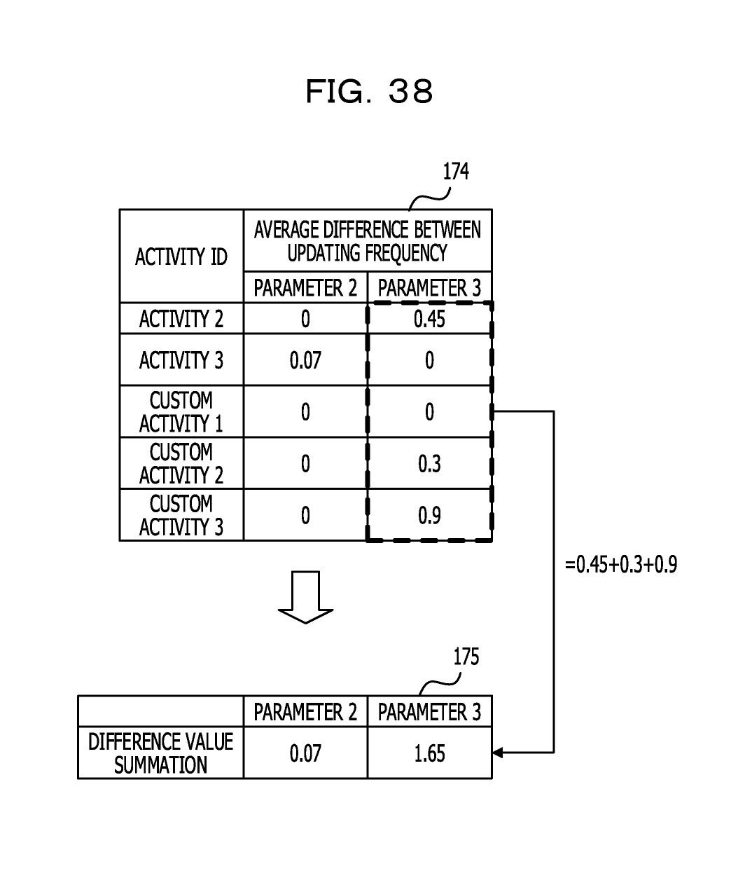

FIG. 38 is a diagram illustrating a calculation example of summation of average updating frequency difference for each candidate parameter. FIG. 38 illustrates a calculation example of summation of average updating frequency difference for parameter 3. As illustrated in FIG. 38, with regard to parameter 3, the summation of average updating frequency difference stored in the average updating frequency difference table 174 is calculated for all activities. In the same way, with regard to parameter 2 as well, the summation of average updating frequency difference stored in the average updating frequency difference table 174 is calculated. As illustrated in FIG. 38, the calculation results are recorded in an average updating frequency difference summation table 175. The average updating frequency difference summation table 175 is generated in the calculation table storage unit 17, for example.

Next, the related parameter identifying unit 134 updates the value of the parameter attribute stored in the parameter attribute table 171 to “related” for the candidate parameter recorded in the average updating frequency difference summation table 175 of which the summation of average updating frequency difference is the greatest (S173).

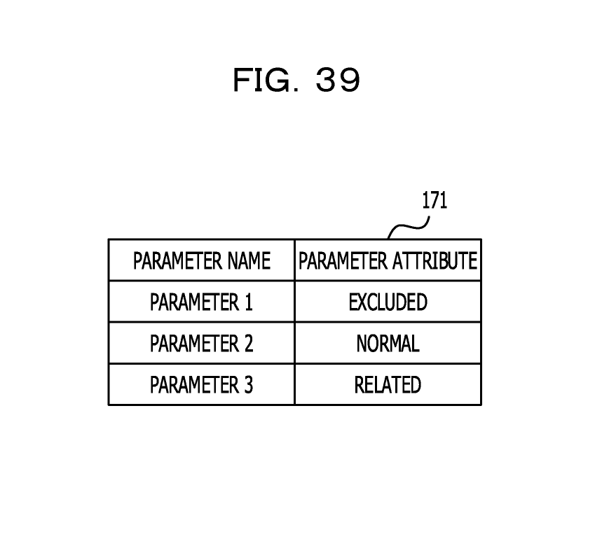

FIG. 39 is a diagram illustrating a second updating example of the parameter attribute table. In the example in FIG. 38, the value as to parameter 3 is the greatest. Accordingly, FIG. 39 illustrates an example where the parameter attribute of parameter 3 has been updated to “related”. The parameter attribute having been updated to “related” means that this parameter has been identified as a related parameter. Note that a parameter of which the parameter attribute is updated to “related” does not have to be restricted to the parameter of which the summation of average updating frequency difference is the greatest. For example, the parameter attribute may be updated to “related” for one or more parameters included within the N′th from the top in summation of average updating frequency difference, or within the top M percent, or for parameters of which the summation is a predetermined value or greater. That is to say, there may be multiple parameters identified as being related parameters.

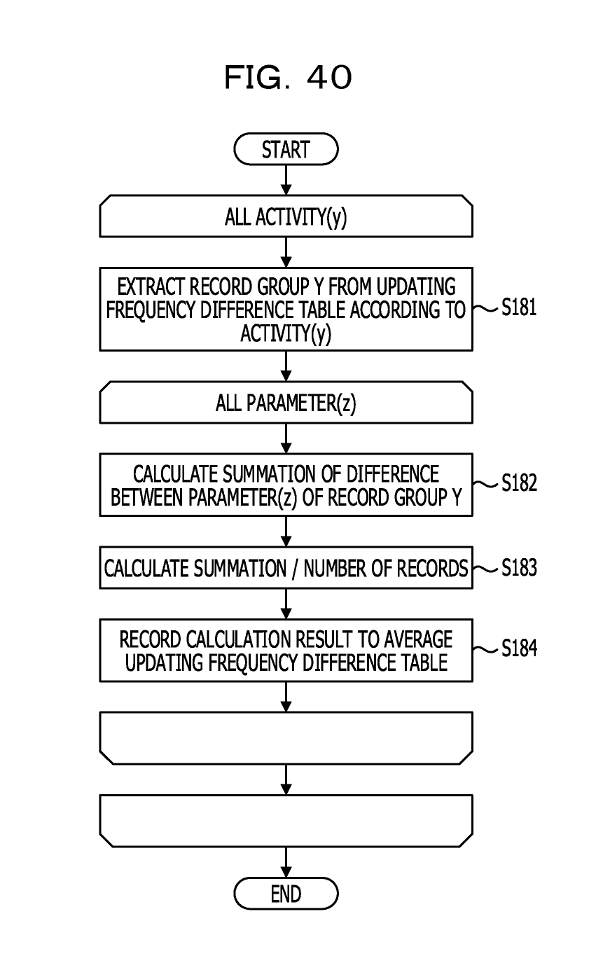

Next, step S171 in FIG. 36 will be described in detail. FIG. 40 is a flowchart for describing an example of processing procedures for calculation processing of average updating frequency difference in increments of activities. In FIG. 40, two loops are nested. The outer loop is a loop y in increments of activities included in custom flows Wc1 through Wc3. Loop processing is executed once for each activity shared among the multiple custom flows (activities 1 through 3, for example). That is to say, loop processing is not executed for each custom flow regarding the same activity. Activities to be processed in loop y will be called “activity (y)”. The inner loop is a loop z of each candidate parameter. Parameters to be processed in loop z will be called “parameter (z)”.

In loop y, upon one activity included being taken as activity (y), the related parameter identifying unit 134 extracts a record group Y corresponding to the activity (y) from the updating frequency difference table 173 (FIG. 31) (S181). The source of extracting is not restricted to a record in a particular custom flow.

Next, in the event of one of the candidate parameters in loop z being taken as parameter (z), the related parameter identifying unit 134 calculates the summation of the difference in updating frequency corresponding to the parameter (z), stored in each record included in the record group Y (S182). Next, by dividing the calculated summation by the number of records in the record group Y, the related parameter identifying unit 134 calculates the average updating frequency difference regarding the parameter (z) (S183). Next, the related parameter identifying unit 134 records the calculated average updating frequency difference in the item of parameter (z) in the record corresponding to activity (y) in the average updating frequency difference table 174 (FIG. 37B) (S184).

Due to the processing described above being executed regarding each activity and each candidate parameter, the average updating frequency difference table 174 illustrated in FIG. 37B is completed.

The following are calculation examples of the average updating frequency differences illustrated in FIG. 37B.

Following calculation is an example of average updating frequency difference of parameter 2 of activity 2.

(custom 1+custom 3)/2=(0+0)/2=0

Following calculation is an example of average updating frequency difference of parameter 3 of activity 2.

(custom 1+custom 3)/2=(0.2+0.7)/2=0.45

Following calculation is an example of average updating frequency difference of parameter 2 of activity 3.

(custom 1+custom 2+custom 3)/3=(0.1+0+0.1)/3=0.07

Following calculation is an example of average updating frequency difference of parameter 3 of activity 3.

(custom 1+custom 2+custom 3)/3=(0+0+0)/3=0

Following calculation is an example of average updating frequency difference of parameter 2 of custom activity 1.

(custom 1)/1=0/1=0

Following calculation is an example of average updating frequency difference of parameter 3 of custom activity 1.

(custom 1)/1=0/1=0

Following calculation is an example of average updating frequency difference of parameter 2 of custom activity 2.

(custom 2)/1=0/1=0

Following calculation is an example of average updating frequency difference of parameter 3 of custom activity 2.

(custom 2)/1=0.3/1=0.3

Following calculation is an example of average updating frequency difference of parameter 2 of custom activity 3.

(custom 3)/1=0/1=0

Following calculation is an example of average updating frequency difference of parameter 3 of custom activity 3.

(custom 3)/1=0.9/1=0.9

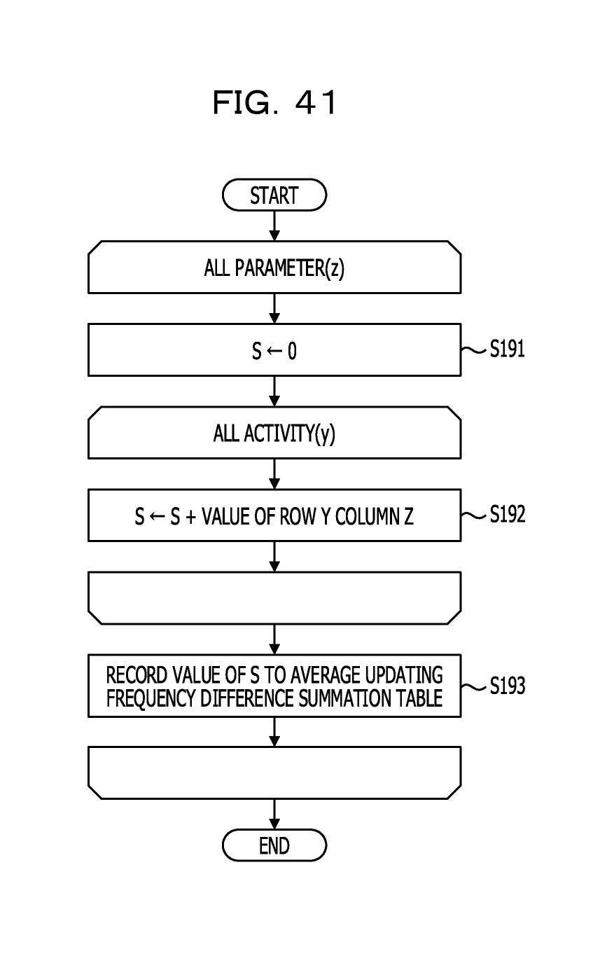

Next, step S172 in FIG. 36 will be described in detail. FIG. 41 is a flowchart for describing an example of processing procedures for calculation processing of summation of the average updating frequency difference for each candidate parameter. In FIG. 41, two loops are nested. The outer loop is a loop z for each candidate parameter, i.e., each column in the average updating frequency difference table 174. Parameters to be processed in loop z will be called “parameter (z)”. The inner loop is a loop y of each activity, i.e., each row in the updating frequency difference table 173. Activities to be processed in loop y will be called “activity (y)”.

In loop z, upon one of the candidate parameters being taken as parameter (z), the related parameter identifying unit 134 initializes to zero the value of a variable S to store the summation of the average updating frequency difference relating to the parameter (z) (S191).

Next, in loop y, upon any one activity being taken as activity (y), in the average updating frequency difference table 174 (FIG. 38) the related parameter identifying unit 134 adds the value of the parameter (z) corresponding to the activity (y) to the variable S (S192). Upon step S192 being performed on all activities (i.e., all records) in the average updating frequency difference table 174, the related parameter identifying unit 134 records the value of the variable S in the item corresponding to the parameter (z) in the average updating frequency difference summation table 175 (FIG. 38) (S193).

Due to the above processing being executed regarding all candidate parameters, the average updating frequency difference summation table 175 illustrated in FIG. 38 is completed.

The following are calculation examples of the difference in each average updating frequency, illustrated in FIG. 38.

Following calculation is an example of difference of average updating frequency of parameter 2. activity 2+activity 3+custom activity 1+custom activity 2+custom activity 3=0+0.07+0+0+0=0.07

Following calculation is an example of difference of average updating frequency of parameter 3. activity 2+activity 3+custom activity 1+custom activity 2+custom activity 3=0.45+0+0+0.3+0.9=1.65

This ends description of related parameter identifying processing in step S103 of FIG. 26. Next, step S104 of FIG. 26 will be described in detail.

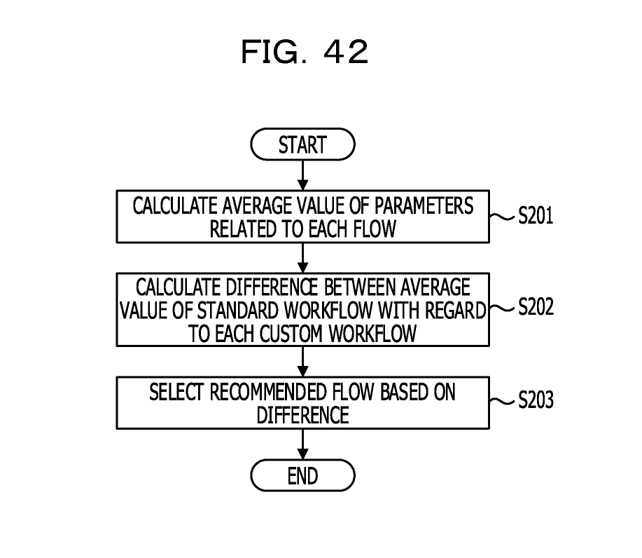

FIG. 42 is a flowchart illustrating an example of processing procedures for recommended flow extracting processing based on related parameters.

In step S201, the related parameter average calculating unit 135 calculates the average value of the value of related parameters stored in the parameter value storage unit 15 (FIG. 23), for each of the standard flow Wd and custom flows Wc1 through Wc3. The calculation results are recorded in a related parameter average value table 176. The related parameter average value table 176 is generated in the calculation table storage unit 17, for example. Note that the related parameter average calculating unit 135 determines the parameter of which the parameter attribute in the parameter attribute table 171 is “related”, as being a related parameter.

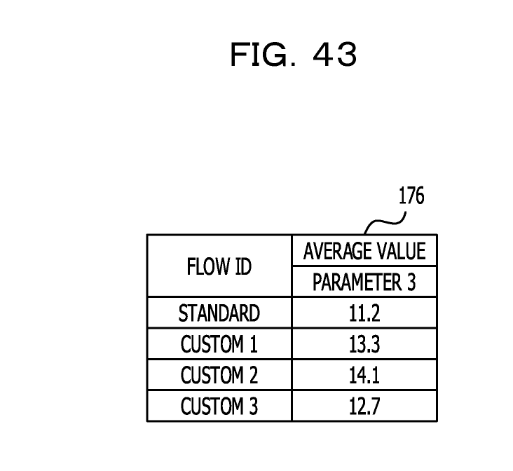

FIG. 43 is a diagram illustrating a configuration example of a related parameter average value table. As illustrated in FIG. 43, the related parameter average value table 176 stores the average value of related parameters stored in the parameter value storage unit 15 for each execution result, for each of the standard flow Wd and custom flows Wc1 through Wc3. This average value may also be said to be the value of a parameter per one execution result. With the present embodiment, parameter 3 is a related parameter, so an example is illustrated where the average value of parameter 3 is stored.

Next, the recommended flow selecting unit 136 calculates the difference between the average values of the related parameters of each of the custom flows Wc1 through Wc3, average values of the related parameters of the standard flow Wd (S202).

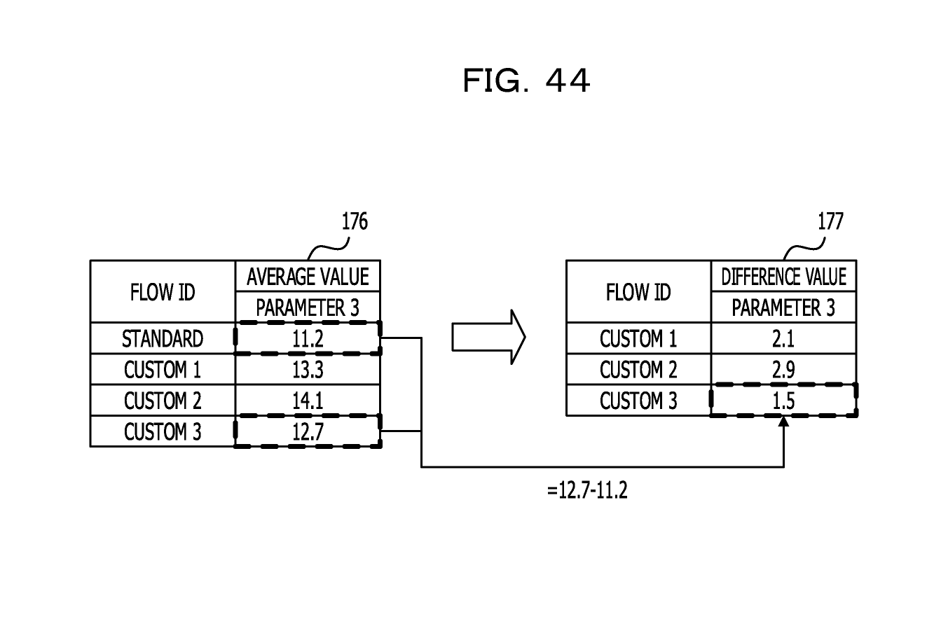

FIG. 44 is a diagram illustrating a calculation example of the difference between the average value of related parameters of each of the custom flows and the average value of related parameters of the standard flow. In FIG. 44, a calculation example of difference relating to the custom flow Wc3 (“custom 3”) is illustrated. The calculation results are recorded in a related parameter average value difference table 177. The related parameter average value difference table 177 is generated in the calculation table storage unit 17, for example.

Next, the recommended flow selecting unit 136 selects the recommended flow based on the difference values which the related parameter average value difference table 177 stores (S203). As described later, a custom flow where the difference is greatest in the positive direction, a custom flow where the difference is greatest in the negative direction, or a custom flow where the absolute value of difference is greatest, is selected as the recommended flow.

The information indicating the recommended flow selected here is returned to the workflow managing device 20 in step S16 in FIG. 14. However, an arrangement may be made where the contents of the related parameter average value difference table 177 are returned to the workflow managing device 20. Alternatively, an arrangement may be made where results of sorting custom flows based on the difference values stored in the related parameter average value difference table 177 are returned to the workflow managing device 20. In this case, the workflow managing device 20 may transfer the retuned information to the business operation terminal 30, so the user may select which workflow to execute.

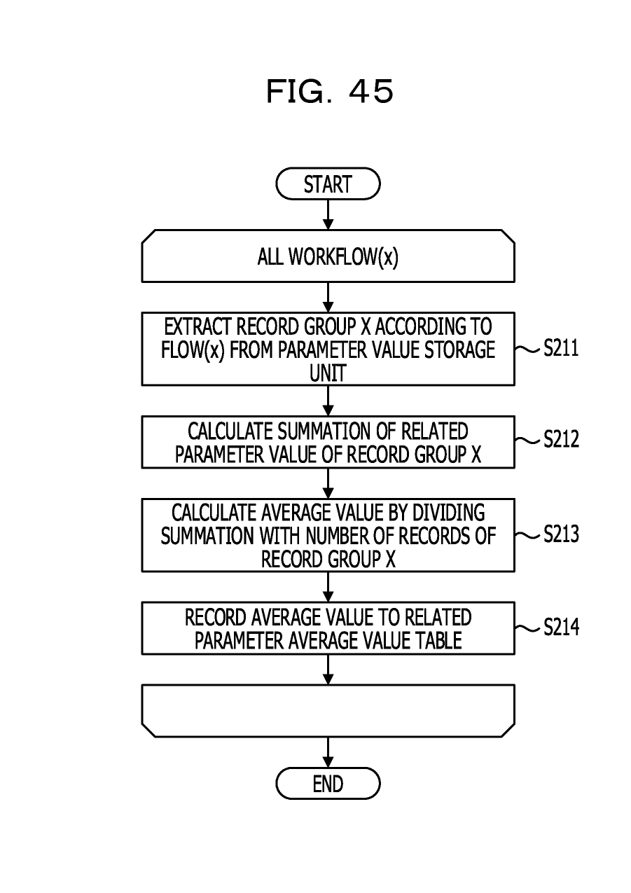

Next, step S201 in FIG. 42 will be described in detail. FIG. 45 is a flowchart for describing an example of processing procedures for average value calculating processing of related parameters for each workflow. Loop x in FIG. 45 is a loop for each of the standard flow Wd and custom flows Wc1 through Wc3. A workflow which is the object of processing in loop x will be called “flow (x)”.

In loop x, the related parameter average calculating unit 135 extracts a record group X corresponding to the flow (x) from the parameter value storage unit 15 (FIG. 23) (S211). For example, in the event that the standard flow Wd is the flow (x), a record group X of which the flow ID is “normal” is extracted from the parameter value storage unit 15.

Next, the related parameter average calculating unit 135 calculates the summation of values of related parameters of each record included in the record group X (S212). Next, the related parameter average calculating unit 135 divides the calculated summation by the number of records included in group X, thereby calculating the average value of the values of related parameters (S213).

Next, the related parameter average calculating unit 135 records the calculated average value in a record corresponding to flow (x) in the related parameter average value table 176 (FIG. 43) (S214).

Due to the above processing being executed for each workflow, the related parameter average value table 176 illustrated in FIG. 43 is completed.

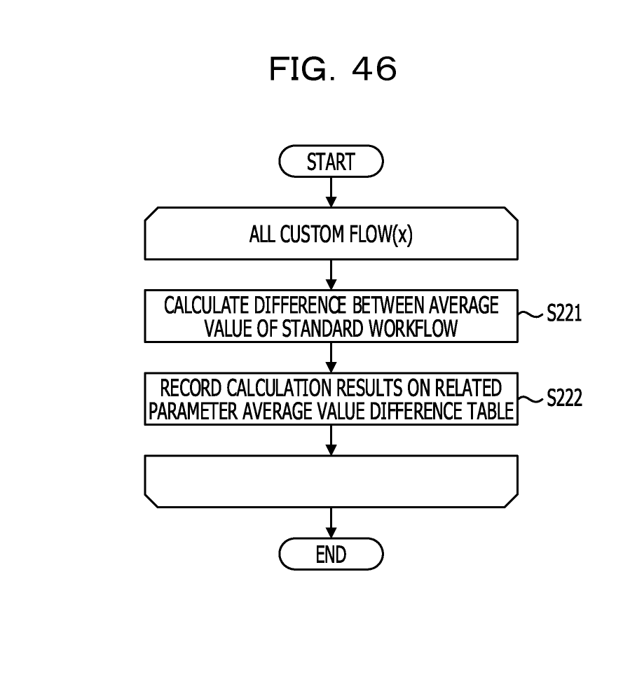

Next, the details of step S202 in FIG. 42 will be described. FIG. 46 is a flowchart for describing an example of processing procedures for calculating processing of the difference between the average value of related parameters for each custom flow and the average value of related parameters for the standard flow. Loop x in FIG. 46 is a loop for each of the custom flows Wc1 through Wc3. A custom flow which is the object of processing in loop x will be called “custom flow (x)”.

In loop x, the recommended flow selecting unit 136 calculates the difference of the two average values by subtracting the average value of the related parameters of the standard flow Wd from the average value of the related parameters of the custom flow (x) (S221). Note that the two average values are obtained from the related parameter average value table 176 (FIG. 43).

Next, the recommended flow selecting unit 136 records the calculation results of the difference in a record corresponding to custom flow (x), in the related parameter average value difference table 177 (FIG. 44) (S222).

Due to the above processing being executed for each custom flow, the related parameter average value difference table 177 illustrated in FIG. 44 is completed.

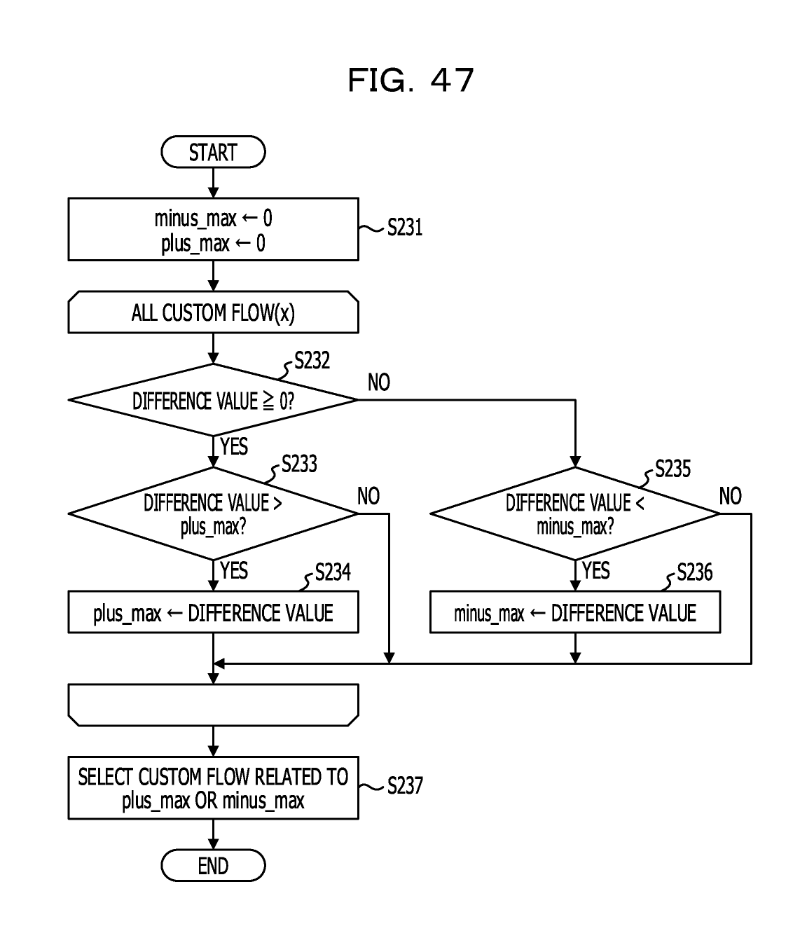

Next, step S203 in FIG. 42 will be described in detail. FIG. 47 is a flowchart for describing a first example of processing procedures for selection processing of a recommended flow based on the difference of related parameters.

In step S231, the recommended flow selecting unit 136 substitutes 0 into both of a variable minus_max and a variable plus_max, as initial values. The variable minus_max is a variable for storing the greatest negative value of the difference values stored in the related parameter average value difference table 177 (FIG. 44) (hereinafter referred to simply as “difference value”). The variable plus_max is a variable for storing the greatest positive value of the difference values.

Next, the recommended flow selecting unit 136 executes loop x. Loop x is a loop for each of the custom flows in the related parameter average value difference table 177 (FIG. 44). A custom flow which is the object of processing in loop x will be called “custom flow (x)”.

In loop x, the recommended flow selecting unit 136 determines whether or not the difference value of the custom flow (x) is 0 or greater (S232). In the event that this difference value is 0 or greater (Yes in S232), the recommended flow selecting unit 136 compares this difference value with the variable plus_max (S233). In the event that this difference value is greater (Yes in S233), the recommended flow selecting unit 136 substitutes this difference value into the variable plus_max (S234).

On the other hand, in the event that this difference value is smaller than 0 (No in S232), the recommended flow selecting unit 136 compares this difference value with the variable minus_max (S235). In the event that this difference value is smaller (Yes in S235), the recommended flow selecting unit 136 substitutes this difference value into the variable minus_max (S236).

Upon loop x ending, the recommended flow selecting unit 136 selects the custom flow of which the difference value matches the variable plus_max or the variable minus_max, as the recommended flow (S237).

That is to say, the processing in FIG. 47 illustrates an example of processing procedures in a case of selecting a custom flow where the difference value is the greatest in the positive direction, or a custom flow where the difference value is the greatest in the negative direction, as the recommended flow. Note that the top N custom flows with regard to difference values in the positive direction or negative direction may be selected as recommended flows.

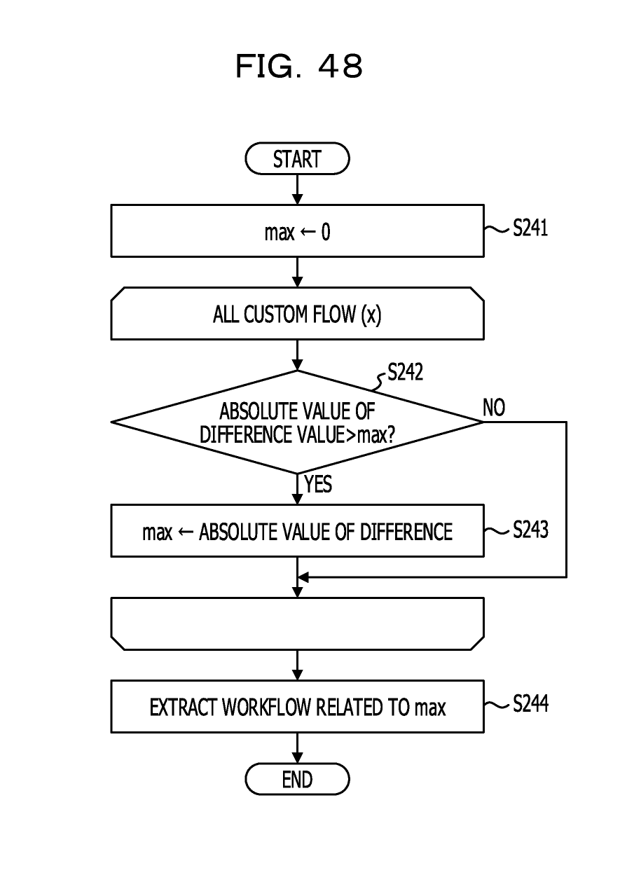

Also, FIG. 48 is a flowchart for describing a second example of processing procedures for selection processing of a recommended flow based on the difference of related parameters.

In step S241, the recommended flow selecting unit 136 substitutes 0 into a variable max as an initial value. The variable max is a variable for storing the greatest absolute value of the difference values stored in the related parameter average value difference table 177 (FIG. 44) (hereinafter referred to simply as “difference value”).

Next, the recommended flow selecting unit 136 executes loop x. Loop x is a loop for each of the custom flows in the related parameter average value difference table 177 (FIG. 44). A custom flow which is the object of processing in loop x will be called “custom flow (x)”.

In loop x, the recommended flow selecting unit 136 compares the absolute value of the difference value of the custom flow (x) with the variable max (S242). In the event that the absolute value of the difference value is greater (Yes in S243), the recommended flow selecting unit 136 substitutes this difference value into the variable max (S243).

Upon loop x ending, the recommended flow selecting unit 136 selects the custom flow of which the absolute value of the difference value matches the variable max as the recommended flow (S244).

That is to say, the processing in FIG. 47 illustrates an example of processing procedures in a case of selecting a custom flow where the absolute value of the difference value is the greatest as the recommended flow. Note that the top N custom flows with regard to the absolute value of difference values may be selected as recommended flows.

Now, no specific example has been described above regarding a case where parameter attribute information has been specified in a workflow extracting request from the workflow managing device 20. Accordingly, a case where parameter attribute information has been specified in a workflow extracting request will be described in detail below. Note that workflows which are the object of processing are the standard flow Wd and custom flows Wc1 through Wc3, the same as above. Also, the state of the parameter value storage unit 15 and update information storage unit 16 at the time of extracting the recommended flow is as illustrated in FIG. 23 or FIG. 29. Accordingly, points that would be redundant with the above will be omitted from description.

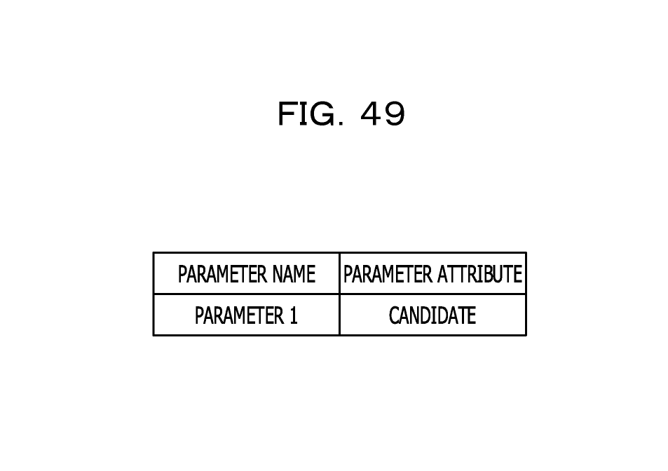

For example, in step S112 in FIG. 24, parameter attribute information such as illustrated in FIG. 49 is extracted.

FIG. 49 is a diagram illustrating an example of parameter attribute information specified in the workflow extracting request. In FIG. 49, an example is illustrated where “candidate” is specified with relation to parameter 1.

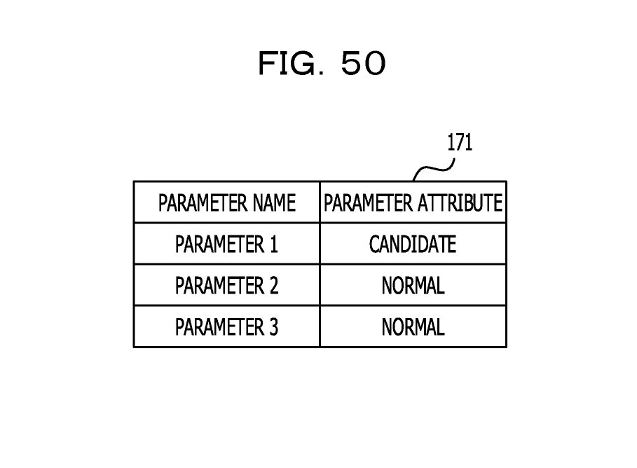

Accordingly, in step S114 the parameter excluding unit 131 updates the parameter attribute table 171 such as illustrated in FIG. 50, based on the contents of the parameter attribute information (S114).

FIG. 50 is a diagram illustrating an updating example of a parameter attribute table, based on parameter attribute information. FIG. 50 illustrates an example where the parameter attribute of parameter 1 has been updated to “candidate”, based on the parameter attribute information illustrated in FIG. 49.

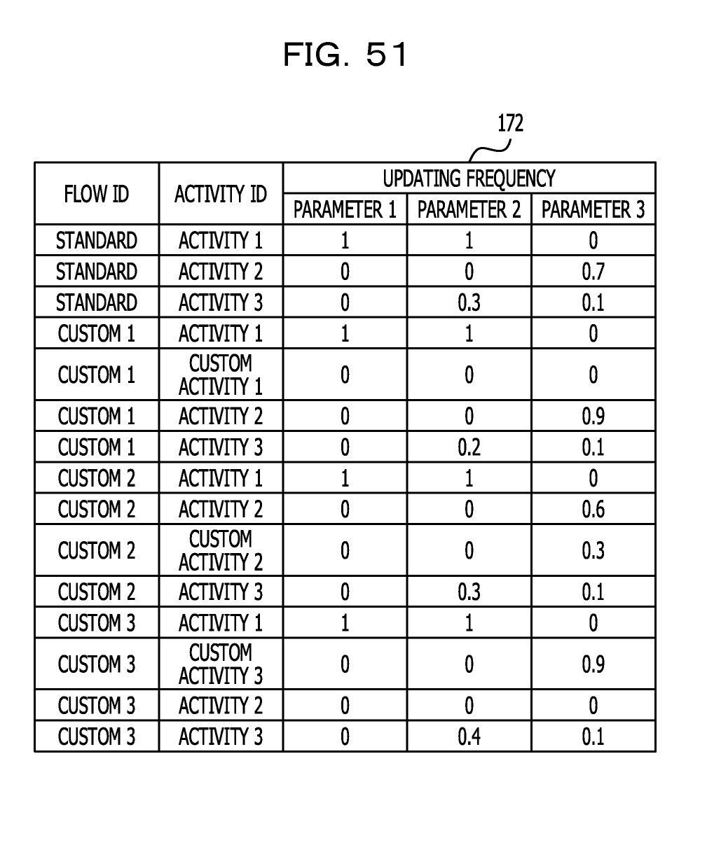

Accordingly, in step S123 of FIG. 26, updating to “excluded” is not performed with regard to the parameter attribute of parameter 1. Accordingly, in the processing in FIG. 33, steps S144 through S146 are executed for parameter 1 as well. AS a result, the updating frequency table 172 generated by the processing in FIG. 33 is such as illustrated in FIG. 51, for example.

FIG. 51 is a diagram illustrating a second specific example of a updating frequency table. The updating frequency table 172 illustrated in FIG. 51 stores the calculation results of updating frequency for parameter 1 as well.

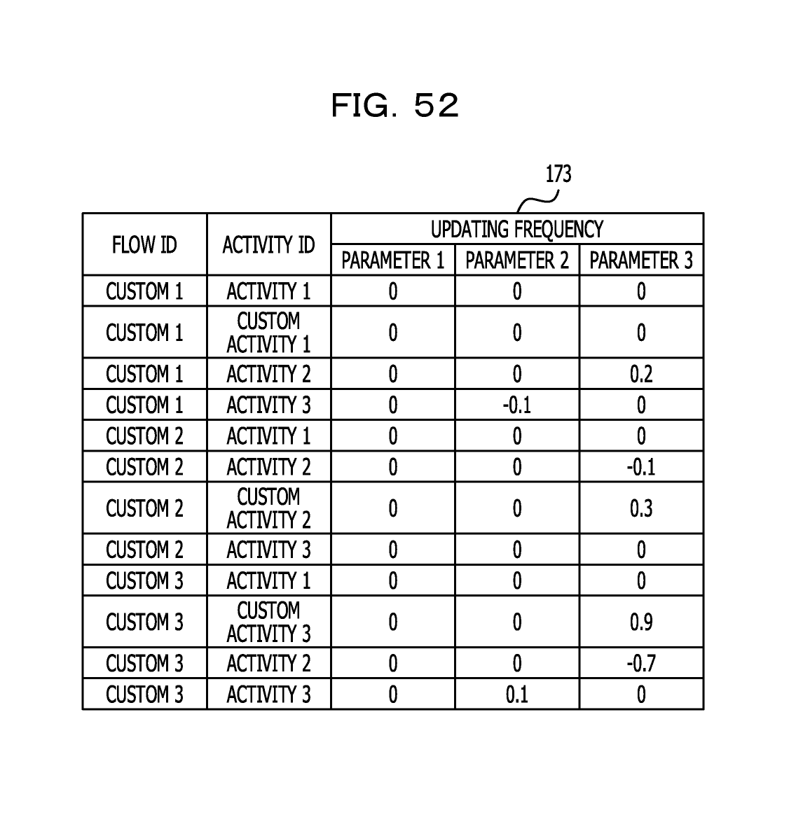

The processing in FIG. 34 generates a updating frequency difference table 173 such as illustrated in FIG. 52, based on the updating frequency table 172 illustrated in FIG. 51.

FIG. 52 is a diagram illustrating a second specific example of a updating frequency difference table. As illustrated in FIG. 52, difference in updating frequency is calculated for parameter 1 as well.

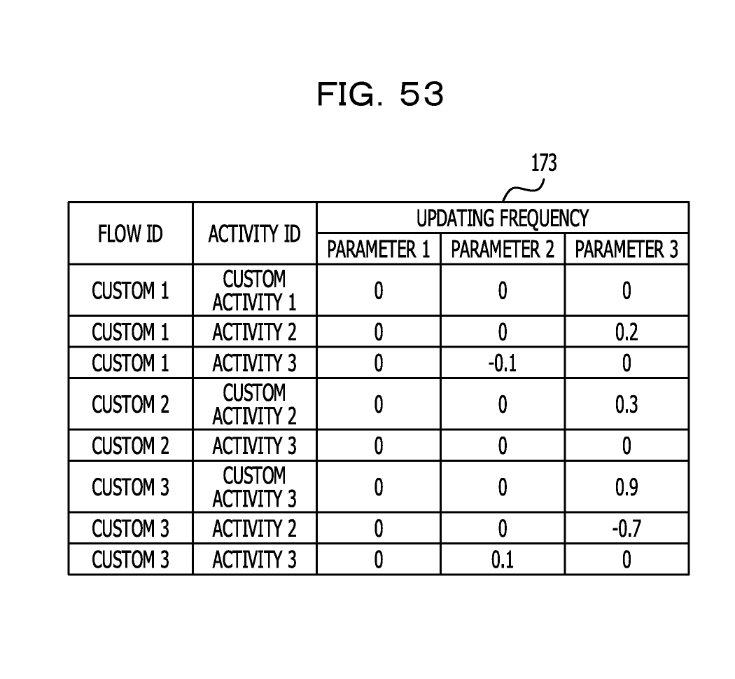

Due to records earlier than custom activity relating to each custom flow being delete by the processing in FIG. 35, the updating frequency difference table 173 illustrated in FIG. 52 is updated as illustrated in FIG. 53.

FIG. 53 is a diagram illustrating a second deleting example of difference in updating frequency relating to activity before a custom activity. The records deleted in FIG. 53 are the same as with the example illustrated in FIG. 32.

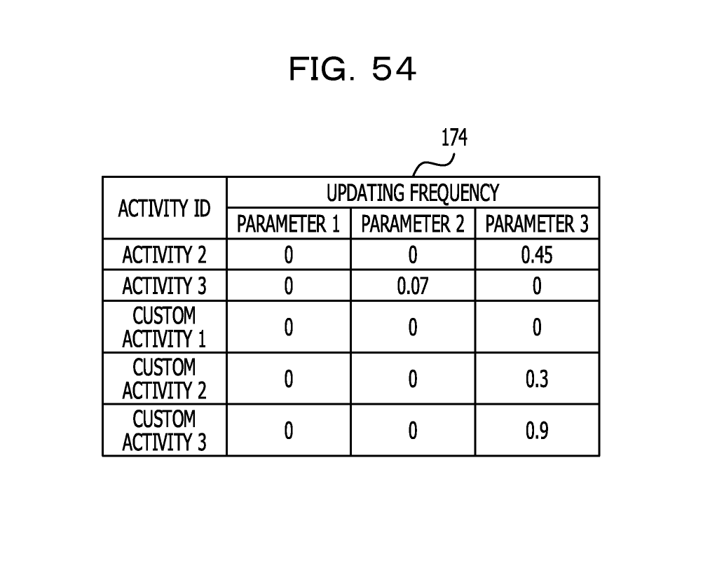

By the processing in FIG. 40 being executed based on the updating frequency difference table 173 illustrated in FIG. 53, the average updating frequency difference is calculated in increments of activities, and an average updating frequency difference table 174 such as illustrated in FIG. 54 is generated.

FIG. 54 is a diagram illustrating a second specific example of an average updating frequency difference table. The average updating frequency difference table 174 illustrated in FIG. 54 stores the average updating frequency difference for parameter 1 as well.

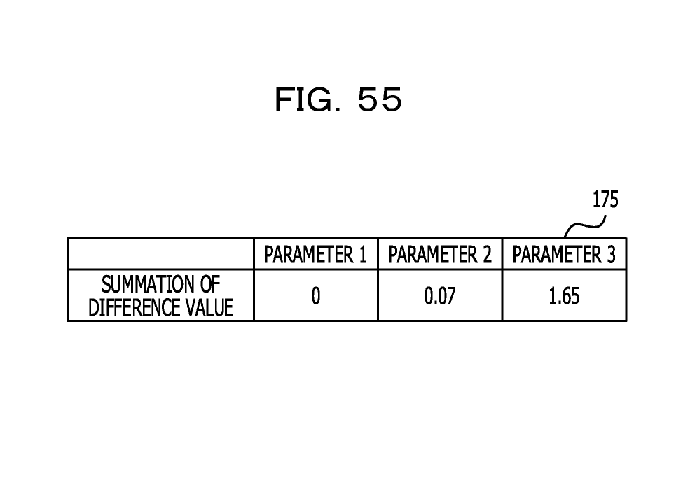

Due to the processing in FIG. 41 being executed based on the average updating frequency difference table 174 illustrated in FIG. 54, the summation of the average updating frequency difference is calculated for each candidate parameter, and the average updating frequency difference summation table 175 such as illustrated in FIG. 55 is generated.

FIG. 55 is a diagram illustrating a second specific example of an average updating frequency difference summation table. The average updating frequency difference summation table 175 illustrated in FIG. 54 stores the summation of average updating frequency differences for parameter 1 as well.

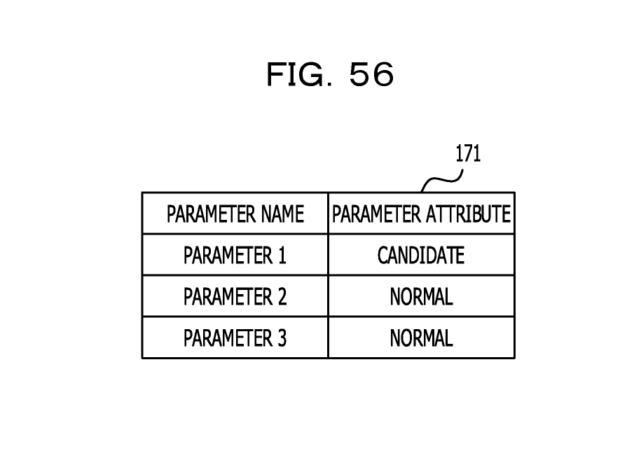

Due to step S173 in FIG. 36 being executed based on the average updating frequency difference summation table 175 illustrated in FIG. 54, the value of the parameter attribute relating to parameter 3 in the parameter attribute table 171 is updated to “related”. As a result, the state of the parameter attribute table 171 is as illustrated in FIG. 56.

FIG. 56 is a diagram illustrating an updating example of a parameter attribute table based on the second specific example of the average updating frequency difference summation table. With the parameter attribute table 171 illustrated in FIG. 56, the parameter attribute of parameter 3 is updated to “related”.

As described above, in step S104 of FIG. 22, parameter 3 is taken as the related parameter, and recommended flow extracting processing is executed. Accordingly, processing the same as the specific example described above is executed.

As described above, with the present embodiment, a related parameter deeply related to the objectives achievement degree is identified, and a custom flow of which difference as to the standard flow with regard to the related parameter is relatively great, is extracted as a recommended flow. A custom flow of which difference as to the standard flow with regard to the related parameters is relatively great has a great likelihood of being a custom flow of which change in objectives achievement degree tends to be relatively great. Accordingly, with the present embodiment, the probability of extracting a custom flow with high usage value from custom flow attempting to achieve the same object, may be raised.

By extracting a custom flow with high usage value, improved quality of the business operation process of the user may be expected. For example, let us say that with regard to a workflow for a business operation processing dealing with sales, the average monthly sales for an employee using a standard flow is $100,000, and the average monthly sales for an employee using a custom flow is $120,000. If there are 20 employees in the sales department, and only the one who has himself customized the flow uses the custom flow, the total average monthly sales for everyone in the sales department will be $2,020,000. On the other hand, in the event that this custom flow is extracted as a recommended flow, and everyone in the sales department uses the custom flow, the total average monthly sales for everyone in the sales department will be $2.4 million. This means an increase of $380,000 in sales as compared to a case of not having extracted this custom flow.

Note that the standard flow and custom flows are relative. Accordingly, the present embodiment may be applied to a set of custom flows obtained by further customizing certain custom flows.

Note that with the present embodiment, the update information storage unit 16 is an example of a first storage unit. The parameter value storage unit 15 is an example of a second storage unit. The update frequency calculating unit 132 is an example of a calculating unit. The related parameter average calculating unit 135 and recommended flow selecting unit 136 are an example of a second extracting unit. The update frequency difference calculating unit 133 and related parameter identifying unit 134 are an example of a first extracting unit.

While an embodiment of the present invention has been described in detail, the present invention is in no way restricted to this embodiment; rather, various modifications and alterations may be made within the scope of the essence of the present invention as laid forth in the Claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An extracting apparatus comprising:
a processor configured to:
calculate a first frequency of updates in a first workflow and second frequencies of updates in each of a plurality of second workflows, each of which includes activities of the first workflow and one or more activities, with regard to each of a plurality of parameters used in the first workflow and the plurality of second workflows;
select a first parameter from the plurality of parameters, based on differences, relating to each of the plurality of parameters, from the first frequency to each of the second frequencies; and
extract a second workflow from the plurality of second workflows, based on differences from a value of the first parameter after termination of the first workflow to each of values of the first parameter after termination of the plurality of second workflows.

2. The extracting apparatus according to claim 1, wherein
the first frequency and the second frequencies is calculated based on update performed in activities after activities added to the plurality of second workflows.

3. The extracting apparatus according to claim 1, wherein
the first parameter is extracted based on the differences from the first frequency to each of second frequencies, relating to each of the plurality of parameters excluding a parameter of which a value after termination of the first workflow and values after termination of the second workflows exhibit a uniform distribution or indicate same values.

4. A computer-readable recording medium storing an extracting program that causes a computer to execute a procedure, the procedure comprising:
calculating a first frequency of updates in a first workflow and second frequencies of updates in each of a plurality of second workflows, each of which includes activities of the first workflow and one or more activities, with regard to each of a plurality of parameters used in the first workflow and the plurality of second workflows;
selecting a first parameter from the plurality of parameters, based on differences, relating to each of the plurality of parameters, from the first frequency to each of the second frequencies; and
extracting a second workflow from the plurality of second workflows, based on differences from a value of the first parameter after termination of the first workflow to each of values of the first parameter after termination of the plurality of second workflows.

5. The recording medium according to claim 4, wherein
the first frequency and the second frequencies is calculated based on update performed in activities after activities added to the plurality of second workflows.

6. The recording medium to claim 4, wherein
the first parameter is extracted based on the differences from the first frequency to each of second frequencies, relating to each of the plurality of parameters excluding a parameter of which a value after termination of the first workflow and values after termination of the second workflows exhibit a uniform distribution or indicate same values.

7. An extracting method comprising:
calculating a first frequency of updates in a first workflow and second frequencies of updates in each of a plurality of second workflows, each of which includes activities of the first workflow and one or more activities, with regard to each of a plurality of parameters used in the first workflow and the plurality of second workflows;
selecting a first parameter from the plurality of parameters, based on differences, relating to each of the plurality of parameters, from the first frequency to each of the second frequencies; and
extracting, by a processor, a second workflow from the plurality of second workflows, based on differences from a value of the first parameter after termination of the first workflow to each of values of the first parameter after termination of the plurality of second workflows.

8. The extracting method according to claim 7, wherein
the first frequency and the second frequencies is calculated based on update performed in activities after activities added to the plurality of second workflows.

9. The extracting method to claim 7, wherein
the first parameter is extracted based on the differences from the first frequency to each of second frequencies, relating to each of the plurality of parameters excluding a parameter of which a value after termination of the first workflow and values after termination of the second workflows exhibit a uniform distribution or indicate same values.
